(19) United States
(12) Patent Application Publication
(10) Pub. No.: US 2009/0219337 A1
(43) Pub. Date: Sep. 3, 2009

(54) METHOD OF RECYCLING CONTAINER MEMBER

(75) Inventors: Shuhei Harada, Chino-shi (JP); Nobuhito Takahashi, Shiojiri-shi (JP); Shinichi Kamoshida, Shiojiri-shi (JP); Tadayuki Yoshimoto, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/394,233

(22) Filed: Feb. 27, 2009

(30) Foreign Application Priority Data
Feb. 29, 2008 (JP) 2008-049541
Feb. 29, 2008 (JP) 2008-049542
Feb. 29, 2008 (JP) 2008-049543
Apr. 25, 2008 (JP) 2008-116109
Apr. 25, 2008 (JP) 2008-116110
Apr. 25, 2008 (JP) 2008-116111

(51) Int. Cl. B41J 2/165; B41J 29/38

(52) U.S. Cl. 347/36; 347/6

(57) ABSTRACT

A method of recycling a container member containing a waste liquid absorbing member includes: removing at least a part of waste liquid from the waste liquid absorbing member having absorbed the waste liquid; and disposing the waste absorbing member, which at least a part of the waste liquid is removed from, in the container member.

### CROSS-REFERENCE TO RELATED APPLICATIONS

The present invention claims the benefit of priority of Japanese Patent Application No. 2008-49541 filed on Feb. 29, 2008, Japanese Patent Application No. 2008-49542 filed on Feb. 29, 2008, Japanese Patent Application No. 2008-49543 filed on Feb. 29, 2008, Japanese Patent Application No. 2008-116109 filed on Apr. 25, 2008, Japanese Patent Application No. 2008-116110 filed on Apr. 25, 2008, and Japanese Patent Application No. 2008-116111 filed on Apr. 25, 2008, the entire contents of which are incorporated herein by reference.

### BACKGROUND

1. Technical Field

The present invention relates to a method of recycling a container member containing a waste liquid absorbing member.

2. Related Art

In the past, for example, an ink jet printer (hereinafter, simply referred to as “printer”) was widely known as a liquid ejecting apparatus ejecting a liquid to a target from nozzle openings formed in a liquid ejecting head. In such a printer, a so-called cleaning process of forcibly sucking and discharging thickened ink as waste ink (waste liquid) from a print head (liquid ejecting head) is performed to prevent the nozzle openings from clogging due to the thickened ink (liquid) and to discharge bubbles and dust mixed into the ink in the print head.

When the waste ink is discharged by the cleaning process, a waste ink tank (waste liquid collector) collecting the discharged waste ink is required. A waste ink absorbing member (waste liquid absorbing member) is contained in the waste ink tank. The waste ink tank contains the discharge waste ink.

Examples of the related art are disclosed in JP-A-2002-29065, JP-A-2006-142630, JP-A-5-162334, and JP-A-2007-130998.

The problem that the invention is to solve is as follows.

That is, the waste ink discharged in the cleaning process can be collected by providing the printer with the waste ink tank, but all the waste ink may not be collected when the waste ink tank is used for a long time. In this case, the waste ink tank should be replaced and the old waste ink tank obtained by the replacement is generally discarded. However, when a reusable container member of the waste ink tank can be reused, it is not necessary to produce a new container member and thus it is advantageous from the point of view of environment and economy.

### SUMMARY

An advantage of some aspects of the invention is to reuse a container member.

The advantage is accomplished as follows.

According to a first aspect of the invention, there is provided a method of recycling a container member containing a waste liquid absorbing member, the method including: removing at least a part of waste liquid from the waste liquid absorbing member having absorbed the waste liquid; and disposing the waste absorbing member, which at least a part of the waste liquid is removed from, in the container member.

The other features of the first aspect of the invention will become apparent from the specification and the accompanying drawings.

The following description will become apparent from the specification and the accompanying drawings:

a method of recycling a container member containing a waste liquid absorbing member, the method including: removing at least a part of waste liquid from the waste liquid absorbing member having absorbed the waste liquid; and disposing the waste absorbing member, which at least a part of the waste liquid is removed from, in the container member.

Accordingly, it is possible to reuse the container member.

In the method of recycling a container member, it is preferable that the removing of at least a part of the waste liquid from the waste liquid absorbing member includes at least one of cleaning the waste liquid absorbing member, squeezing the waste liquid absorbing member, wiping the waste liquid absorbing member, and cleaning the container member as a whole with the waste liquid absorbing member contained therein. It is also preferable that the waste liquid absorbing member includes a plurality of waste liquid absorbing members and the waste liquid absorbing member from which the waste liquid is more removed is disposed in a lower part in the container member in the disposing of the waste liquid absorbing member, which at least a part of the waste liquid is removed from, in the container member. The waste liquid absorbing member from which a part of the waste liquid is removed and a non-used waste liquid absorbing member may be disposed in container member in the disposing of the waste liquid absorbing member, which at least a part of the waste liquid is removed from, in the container member. The outer shape of the non-used waste liquid absorbing member may be different from the outer shape of the waste liquid absorbing member from which a part of the waste liquid is removed.

It is preferable that the method may further include sealing at least a part of an opening of the container member. It is preferable that the sealing of at least a part of the opening of the container member includes at least one of shaving at least a part of a top portion of a side wall constituting the opening and attaching a sealing member to the top portion of the side wall, winding the sealing member around the container member, attaching the sealing member to a side wall surface of the container member, and providing a lid member inserted into at least a part of the top portion of the side wall of the container member. It is also preferable that the container member includes a memory device storing information on an amount of the collected waste liquid and that the method further comprises at least one of rewriting the information on the amount of collected waste liquid to the memory device and replacing the memory device with a new memory device.

Accordingly, it is possible to reuse the container member.

According to a second aspect of the invention, there is provided a method of recycling a container member containing a waste liquid absorbing member, including: removing the waste liquid absorbing member absorbing a waste liquid from the container member; and disposing a different waste liquid absorbing member in the container member instead of the removed waste liquid absorbing member.

The other features of the second aspect of the invention will become apparent from the specification and the accompanying drawings.

The following description will become apparent from the specification and the accompanying drawings:

a method of recycling a container member containing a waste liquid absorbing member, including: removing the waste liquid absorbing member absorbing a waste liquid from the container member; and disposing a different waste liquid absorbing member in the container member instead of the removed waste liquid absorbing member.

Accordingly, it is possible to reuse the container member.

In the method of recycling a container member, it is preferable that the different waste liquid absorbing member disposed instead of the removed waste liquid absorbing member has the same shape as the outer shape of the removed waste liquid absorbing member. The different waste liquid absorbing member disposed instead of the removed waste liquid absorbing member may have a shape different from the outer shape of the removed waste liquid absorbing member. The different waste liquid absorbing member disposed instead of the removed waste liquid absorbing member may have an outer shape larger than the inner shape of the container member. The different waste liquid absorbing member disposed instead of the removed waste liquid absorbing member may be folded and disposed in the container member.

The different waste liquid absorbing member disposed instead of the removed waste liquid absorbing member may be disposed in a part of the container member. The different waste liquid absorbing member disposed instead of the removed waste liquid absorbing member may be divided into a plurality of waste liquid absorbing members and disposed in the container member. A connection port which a liquid passage can be inserted into and detached from may be formed in the container member and the different waste liquid absorbing member disposed instead of the removed waste liquid absorbing member may be disposed close to the connection port in the container member. A connection port which a liquid passage can be inserted into and detached from may be formed in the container member and the different waste liquid absorbing member disposed instead of the removed waste liquid absorbing member may be disposed close to a wall surface opposed to the connection port in the container member. A connection port which a liquid passage can be inserted into and detached from may be formed in the container member and the different waste liquid absorbing member disposed instead of the removed waste liquid absorbing member may be disposed below the connection port in the container member.

The different waste liquid absorbing member disposed instead of the removed waste liquid absorbing member may be formed of a material different from that of the waste liquid absorbing member having absorbed the waste liquid. It is preferable that the method of recycling a container member further includes sealing at least a part of an opening of the container member. It is preferable that the sealing of at least a part of the opening of the container member includes at least one of shaving at least a part of a top portion of a side wall constituting the opening and attaching a sealing member to the top portion of the side wall, winding the sealing member around the container member, attaching the sealing member to a side wall surface of the container member, and providing a lid member inserted into at least a part of the top portion of the side wall of the container member. It is preferable that the container member includes a memory device storing information on an amount of the collected waste liquid and the method further comprises at least one of rewriting the information on the amount of collected waste liquid to the memory device and replacing the memory device with a new memory device.

Accordingly, it is possible to reuse the container member.

According to a third aspect of the invention, there is provided a method of recycling a container member containing a waste liquid absorbing member, including: removing the waste liquid absorbing member having absorbed a waste liquid from an opening of the container member; and sealing at least a part of the opening of the container member from which the waste liquid absorbing member is removed.

The other features of the third aspect of the invention will become apparent from the specification and the accompanying drawings.

The following description will become apparent from the specification and the accompanying drawings:

a method of recycling a container member containing a waste liquid absorbing member, including: removing the waste liquid absorbing member having absorbed a waste liquid from an opening of the container member; and sealing at least a part of the opening of the container member from which the waste liquid absorbing member is removed.

Accordingly, it is possible to reuse the container member.

It is preferable that the method of recycling a container member further includes cleaning the inside of the container member after removing the waste liquid absorbing member. It is preferable that the sealing of at least a part of the opening of the container member includes at least one of shaving at least a part of a top portion of a side wall constituting the opening and attaching a sealing member to the top portion of the side wall, winding the sealing member around the container member, attaching the sealing member to a side wall surface of the container member, and providing a lid member inserted into at least a part of the top portion of the side wall of the container member. It is preferable that the container member includes a connection port which a liquid passage can be inserted into and detached from and a rib extending from the bottom of the container member to the vicinity of the connection port and the rib guides the liquid passage in a predetermined direction in the container member at the time of inserting the liquid passage. It is also preferable that the container member includes a memory device storing information on an amount of the collected waste liquid and the method further comprises at least one of rewriting the information on the amount of collected waste liquid to the memory device and replacing the memory device with a new memory device.

Accordingly, it is possible to reuse the container member.

### BRIEF DESCRIPTION OF THE DRAWINGS

The invention will be described with reference to the accompanying drawings, wherein like numbers reference like elements.

FIG. 1 is a perspective view illustrating an ink jet printer according to an embodiment of the invention.

FIG. 2 is a partially-omitted sectional view illustrating a housing in a printer.

FIG. 3 is an exploded perspective view illustrating a waste ink tank according to a first embodiment.

FIG. 4 is an exploded perspective view illustrating a tube supporting mechanism.

FIG. 5A is a partially-exploded front view illustrating the tube supporting mechanism in a normal state and FIG. 5B is a partially-exploded front view illustrating the tube supporting mechanism in a state where a support member retreats.

FIG. 6 is a partially-omitted sectional view (first) illustrating the inside of a receiving chamber at the time of detaching the waste ink tank.

FIG. 7 is a partially-omitted sectional view (second) illustrating the inside of the receiving chamber at the time of detaching the waste ink tank.

FIG. 8 is a flowchart illustrating a method of recycling a container member according to an embodiment of the invention.

FIG. 9 is a diagram illustrating a state where a part of a film member is attached to the periphery of an opening.

FIG. 10 is a diagram illustrating a state where the film member is welded to a part of the opening.

FIG. 11 is a diagram illustrating a state where a film member is wound around the container member.

FIG. 12 is a diagram illustrating a state where a film member is attached using a side wall of the container member.

FIG. 13 is a diagram illustrating a state where a lid member is attached to at least a part of the opening of the container member.

FIG. 14 is a diagram illustrating a state where a connection terminal is detached from the container member.

FIG. 15 is a flowchart illustrating a method of recycling a container member according to an embodiment of the invention.

FIG. 16 is a diagram illustrating a state where a piece of ink absorbing member is received in the container member.

FIG. 17 is a sectional view illustrating a state where an ink absorbing member is received on only the bottom surface of the container member.

FIG. 18 is a top view illustrating a state where plural ink absorbing members are received in the container member.

FIG. 19 is a top view illustrating a state where an ink absorbing member is received in the vicinity of a connection port of the container member.

FIG. 20 is a sectional view illustrating a state where the ink absorbing member is folded and contained.

FIG. 21 is a diagram illustrating a state where a part of a film member is attached to the periphery of an opening.

FIG. 22 is a diagram illustrating a state where the film member is welded to a part of the opening.

FIG. 23 is a diagram illustrating a state where a film member is wound around the container member.

FIG. 24 is a diagram illustrating a state where a film member is attached using a side wall of the container member.

FIG. 25 is a diagram illustrating a state where a lid member is attached to at least a part of the opening of the container member.

FIG. 26 is a diagram illustrating a state where a connection terminal is detached from the container member.

FIG. 27 is a flowchart illustrating a method of recycling a container member according to an embodiment of the invention.

FIG. 28 is a diagram illustrating a state where a part of a film member is attached to the periphery of the opening.

FIG. 29 is a diagram illustrating a state where the film member is welded to a part of the opening.

FIG. 30 is a diagram illustrating a state where a film member is wound around the container member.

FIG. 31 is a diagram illustrating a state where a film member is attached using a side wall of the container member.

FIG. 32 is a diagram illustrating a state where a lid member is attached to at least a part of the opening of the container member.

FIG. 33 is a diagram illustrating a state where a connection terminal is detached from the container member.

FIG. 34 is a diagram illustrating a rib in the vicinity the connection port in the container member.

### DESCRIPTION OF EXEMPLARY EMBODIMENTS

Hereinafter, a first embodiment of the invention will be described.

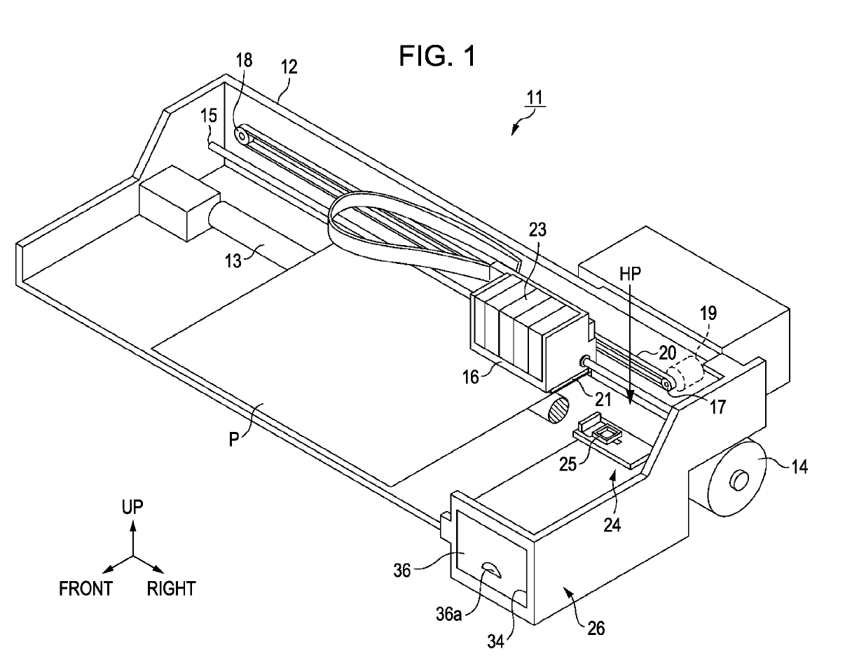

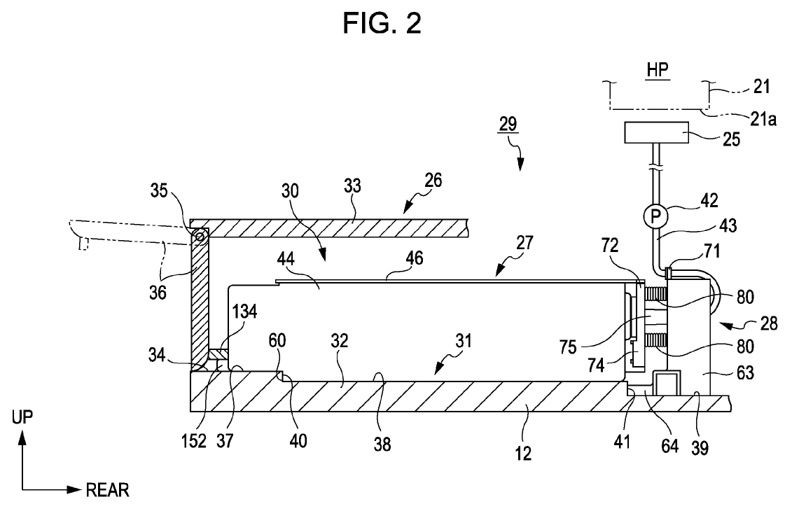

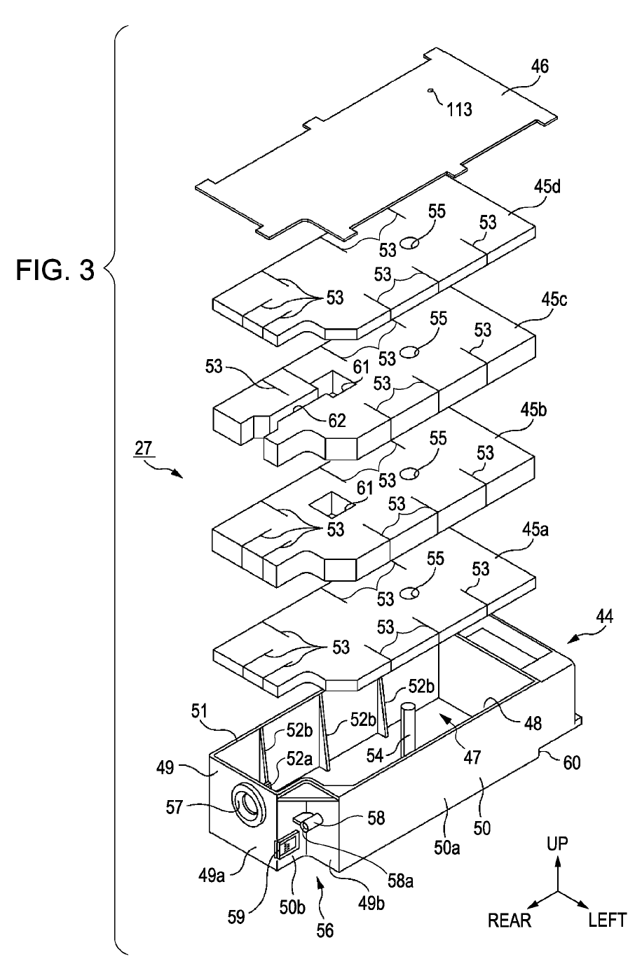

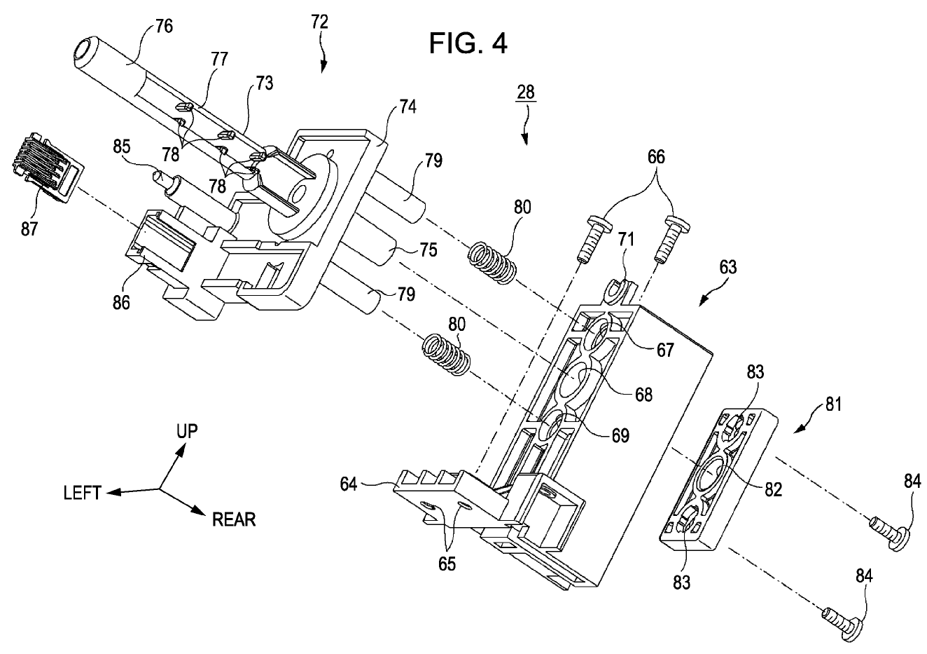

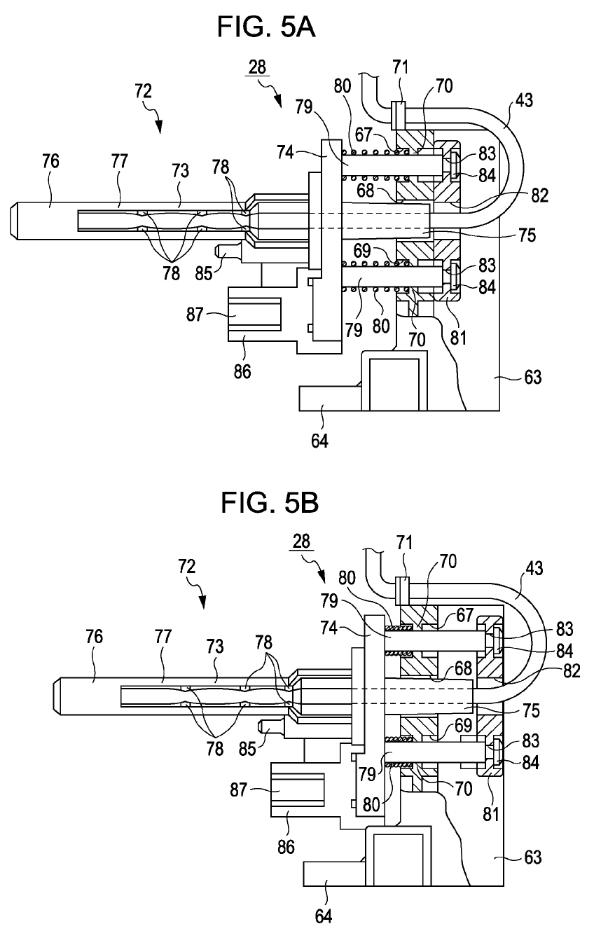

FIG. 1 is a perspective view illustrating an ink jet printer according to the first embodiment of the invention. FIG. 2 is a partially-omitted sectional view illustrating a housing in the printer. FIG. 3 is an exploded perspective view illustrating a waste ink tank. FIG. 4 is an exploded perspective view illustrating a tube supporting mechanism. FIG. 5A is a partially-exploded front view illustrating the tube supporting mechanism and FIG. 5B is a partially-exploded front view illustrating the tube supporting mechanism in a state where a support member retreats.

Hereinafter, a waste liquid collecting system in an ink jet printer which is a kind of liquid ejecting apparatus will be described with reference to the drawings. “Front and rear directions”, “up and down directions”, and “right and left directions” in the following description means “front and rear directions”, “up and down directions”, and “right and left directions” indicated by arrows in FIGS. 1 to 4.

As shown in FIG. 1, an ink jet printer (hereinafter, referred to as “printer”) 11 as a liquid ejecting apparatus according to this embodiment includes a frame 12 having a rectangular shape in a plan view.

A transport roller 13 extends in the right and left directions in the frame 12. A printing sheet P is fed from the rear side to the front side by allowing the transport roller 13 to rotate by the use of a sheet feeding motor 14. In addition, a guide shaft 15 extending in parallel to a longitudinal direction (the right and left directions) of the transport roller 13 is disposed above the transport roller 13 in the frame 12.

A carriage 16 is supported by the guide shaft 15 so as to reciprocate along an axial line direction (the right and left directions) of the guide shaft 15. A driving pulley 17 and a driven pulley 18 are rotatably supported at positions corresponding to both ends of the guide shaft 15 in the rear surface of the frame 12, respectively. A carriage motor 19 serving as a driving source for allowing the carriage 16 to reciprocate is connected to the driving pulley 17. A timing belt 20 fixing and supporting the carriage 16 is suspended between the pair of pulleys 17 and 18. Accordingly, the carriage 16 moves in the right and left directions through the timing belt 20 by the carriage motor 19 while being guided by the guide shaft 15.

As shown in FIG. 1, a print head 21 as a liquid ejecting head is disposed on the lower surface of the carriage 16. On the other hand, plural ink cartridges 23 (five ink cartridges in this embodiment) for supplying ink as a liquid to the print head 21 are detachably mounted on the carriage 16. The ink cartridges 23 individually correspond to plural nozzle opening lines (not shown) formed in a nozzle formation surface 21a (see FIG. 2) which is the lower surface of the print head 21 and individually supply ink to the corresponding nozzle opening lines through ink passages (not shown) formed in the print head 21.

A home position HP serving as a maintenance position where the carriage 16 is located at the time of turning off the printer 11 or maintaining the print head 21 is disposed in one end (the right end in FIG. 1) in the frame 12, that is, in a non-printing area which the printing sheet P does not reach. In addition, a maintenance unit 24 performing various maintenance operations is disposed below the home position HP so as to satisfactorily eject ink to the printing sheet P from the print head 21.

The maintenance unit 24 includes a cap 25 having a substantially rectangular shape corresponding to the lower surface (the nozzle formation surface) of the print head 21 and an elevation mechanism (not shown) moving up and down the cap 25. In addition, when the cap 25 moves up by the driving of the elevation mechanism (not shown) with the carriage 16 located at the home position HP, the cap 25 comes in contact with the nozzle formation surface 21a which is the lower surface of the print head 21 so as to surround the nozzle opening lines.

As shown in FIGS. 1 and 2, a housing 26 having a rectangular parallelepiped shape in the front and rear directions is formed at one end (the right end in FIG. 1) in the frame 12 and below the home position HP. A receiving chamber 30 receiving a waste liquid collecting system 29 including a waste ink tank 27 as a waste liquid collector and a tube supporting mechanism 28 as a liquid passage forming unit is formed in the housing 26. An attachment location 31 of the waste ink tank 27 is set in a lower portion of the receiving chamber 30. As shown in FIG. 2, the height (which is a distance between a bottom wall 32 and a top wall 33) of the receiving chamber 30 is set sufficiently higher than the height of the waste ink tank 27 so that the waste ink tank 27 can be tilted inside the receiving chamber 30.

When the cap 25 moves up from the state shown in FIG. 2 by the driving of the elevation mechanism (not shown) and comes in contact with the nozzle formation surface 21a of the print head 21, a suction pump 42 is driven. Then, the thickened ink in the print head 21 is forcibly sucked and discharged (ejected) as waste ink into the cap 25 through nozzle openings (not shown) by a negative pressure generated in the cap 25. When an idle suction state of sucking the atmospheric air is reached by exposing the inside of the cap 25 to the atmospheric air in a state where the suction pump 42 is being driven, the waste ink is discharged from the cap 25 to the waste ink tank 27.

A rectangular attachment and detachment port 34 through which the waste ink tank 27 passes upon attaching or detaching the waste ink tank 27 to or from the attachment location 31 in the receiving chamber 30 is formed on the front surface of the housing 26. A door 36 of which the upper end portion is rotatably supported on a pair of right and left shafts 35 formed at both ends of the upper edge of the attachment and detachment port 34 is disposed in the attachment and detachment port 34. By grasping a knob 36a formed on the front surface of the door 36 and opening or closing the door 36 about the shafts 35, the door 36 moves between a closing location indicated by a solid line and an opening location indicated a two-dot chain line in FIG. 2.

A pressing member 134 pressing a front protruding portion 152 of the waste ink tank 27 from the upside is formed monolithically with the door 36. Accordingly, it is possible to prevent the front side of the waste ink tank 27 from floating, by closing the door 36.

As shown in FIG. 2, in the receiving chamber 30 of the housing 26, a front step surface 37, a middle step surface 38, and a rear step surface 39 are formed in a step shape on the upper surface of the bottom wall 32 from the front side to the rear side in the front and rear directions. The front step surface 37 has the same height as the lower edge of the attachment and detachment port 34. A locking step 40 as a locking portion making the middle step surface 38 lower than the front step surface 37 is formed between the rear end of the front step surface 37 and the front end of the middle step surface 38 so as to extend in the right and left directions.

The middle step surface 38 has a length in the front and rear directions slightly smaller than the length of the waste ink tank 27 in the front and rear directions. The almost entire area of the middle step surface 38 and the rear half area of the front step surface 37 form the attachment location 31 of the waste ink tank 27. The rear step surface 39 is slightly lower than the middle step surface 38 with a stepped portion 41 interposed therebetween. The tube supporting mechanism 28 supporting a flexible tube 43, which discharges the ink forcibly sucked as the waste ink (waste liquid) from the cap 25 to the waste ink tank 27 by the driving of the suction pump 42, is disposed on the rear step surface 39.

The waste ink tank 27 will be described now. As shown in FIG. 3, the waste ink tank 27 includes a container member 44 having a bottomed box shape of which the top is opened, plural ink absorbing members (waste liquid absorbing members) 45a to 45d having an outer shape corresponding to the opening shape of the container member 44, and a film member 46 as a gas-liquid non-transmitting member having an outer shape similarly corresponding to the opening shape of the container member 44. The inside of the container member 44 serves as a receiving space 47 and the ink absorbing members 45a to 45d are stacked and received in the receiving space 47. The opening 48 of the container member 44 is sealed by bonding (welding in this embodiment) the film member 46 to the container member 44 to cover the opening 48 of the container member 44 having received the ink absorbing members 45a to 45d are received. An air hole 113 is formed at a position of the film member 46 bonded to the container member 44. As described above, the front protruding portion 152 is formed in the container member 44 so as to extend in the right and left directions.

Ribs 52 having a thin plate shape are formed in the up and down directions in the inner surface of a rear side wall 49 of the container member 44. Similarly, ribs 52b having a thin plate shape are formed in the up and down directions on right and left side walls 50 and 51. Only one rib 52a on the rear side wall 49 and three ribs 52b on the right side wall 51 are shown in FIG. 3. In addition, cut-in portions 53 are formed in the outer edges of the ink absorbing members 45a to 45d so as to correspond to the positions of the ribs 52a and 52b.

A columnar post 54 is formed upright at a position slightly closer to the front than the center of the bottom surface of the container member 44. Round holes 55 are formed at a position slightly closer to the front than the center of the ink absorbing members 45 so as to correspond to the post 54. The corresponding ribs 52a and 52b are inserted into the cut-in portions 53 and the post 54 is inserted into the holes 55, whereby the ink absorbing members 45a to 45d are stacked and received in the receiving space 47 of the container member 44.

As shown in FIG. 3, a concave portion 56 is formed in the rear-left corner of the container member 44. As a result, the rear side wall 49 is divided into a main rear side wall 49a located on the relative rear side and a sub rear side wall 49b located on the relative front side and the left side wall 50 is divided into a main left side wall 50a located on the relative left side and a sub left side wall 50b located on the relative right side.

A round connection port 57 is formed in the main rear side wall 49a. The connection port 57 has a diameter which gradually decreases from the opening edge to a deep side and has a function of guiding a member to a deep center of the connection port 57 when the member inserted into the connection port 57 from the outside comes in contact with the inner circumferential surface of the connection port 57 in the front and rear directions. Specifically, since the inner circumferential surface of the connection port 57 in the waste ink tank 27 is a tapered surface of which the diameter decreases to the deep side of the connection port 57, a tubular body 73 of a support member 72 to be described later is slidably guided to the center of the connection port 57 as it is inserted into the connection port 57.

The shape of the connection port 57 is not limited to the round shape. The connection port 57 may have, for example, a triangular shape, a polygonal shape, or an elliptical shape. In the drawing, the connection port 57 protrudes more than the rear side wall 49, but may be formed not to protrude.

A cylinder portion 58 protrudes to the rear side from the sub rear side wall 49b and the hole of the cylinder portion 58 forms a positioning hole 58a. As described later, a positioning pin 85 protruding from a brim portion 74 of the support member 72 is inserted into the positioning hole 58a of the cylinder portion 58. Accordingly, the positioning pin 85 and the positioning hole 58a serve as a holding unit holding the waste ink tank 27 to regulate the movement thereof in the up and down directions and the right and left directions at the attachment location 31.

When the shape of the positioning pin 85 is not cylindrical, the shape of the positioning hole 58a may not be cylindrical. For example, when the outer shape of the positioning pin 85 is rectangular, the positioning hole 58a may be a hole having a concave portion into which the pin is inserted. When the positioning pin 85 is a simple plate-like member, the positioning hole 58a may be a plate-like member capable of coming in contact with the pin to position the pin.

A connection terminal 59 having a circuit board storing various information of the waste ink tank 27 to be described later is mounted on the outer surface of the sub left side wall 50b. A locking stepped portion 60 engaging with the locking stepped portion 40 formed on the bottom wall 32 of the housing 26 in the front and rear directions is formed at a position slightly closer to the rear end than the front end of the bottom surface of the container member 44 so as to extend in the right and left directions.

As shown in FIG. 3, among the ink absorbing members 45a to 45d, the lowermost first ink absorbing member 45a and the uppermost fourth ink absorbing member 45d have the same thickness and the same shape and the second ink absorbing member 45b stacked as the second layer from the bottom and the third ink absorbing member 45c stacked as the third layer from the bottom have the same thickness. A through-hole 61 having a square shape is formed in a position slightly closer to the rear side than the center in each of the second ink absorbing member 45b and the third ink absorbing member 45c. A cut-in groove 62 having a predetermined width is formed in the third ink absorbing member 45c in the front and rear directions from the rear edge to the through hole 61.

As shown in FIG. 3, the first ink absorbing member 45a stops the through hole 61 from the downside and the fourth ink absorbing member 45d stops the through hole 61 from the upside. When a front tubular portion 76 is inserted into the cut-in groove 62, the waste ink discharged from the front tubular portion 76 drops on the top surface of the first ink absorbing member 45a and is absorbed therein. As the amount of waste ink absorbed increases, the waste ink slowly diffuses from the first ink absorbing member 45a to the upper ink absorbing members.

Here, when the amount of waste ink is great, the waste ink cannot diffuse into the first ink absorbing member 45a. Accordingly, the through hole 61 temporarily stores the waste ink. That is, the discharged waste ink is stored until the waste ink is absorbed by the ink absorbing members (the waste ink diffuses into the ink absorbing members). Therefore, it is preferable that the through hole 61 has such a size to contain the discharged waste ink. When the container member 44 is detached and the posture of the container member 44 is upside-down in the state where the through hole 61 stores the waste ink, the fourth ink absorbing member 45d absorbs the waste ink stored in the through hole 61 to prevent the ink from leaking to the outside of the container member 44. The fourth ink absorbing member 45d suppresses the discharged waste ink from vaporization. When the waste ink is vaporized, the ink absorbing member clogs due to the thickened ink and thus the waste ink discharged later hardly diffuses therein. The fourth ink absorbing member 45d stops the through hole 61 to suppress the waste ink from vaporization from the top surface of the first ink absorbing member 45a onto which the discharged waste ink drops and is located above the ink absorbing members 45a, 45b, and 45c to suppress the waste ink from vaporization from the three ink absorbing members.

The waste ink tank 27 is constructed as described above. The ink absorbing members may be received in the container member 44 in a manner different from the above description. Similarly to the recycled waste ink tank 127 to be described later, the sealing member may seal at least a part of the opening of the container member 44 in a manner different from the above description.

The tube supporting mechanism 28 will be described now. As shown in FIG. 4 and FIGS. 5A and 5B, the tube supporting mechanism 28 includes a base body 63 having a substantial ⊃ shape in a plan view in which a front end distance between both side walls having a rectangular shape is constant and in which the front ends of both side walls are connected to each other with a rectangular front wall. A horizontal plate 64 having a rectangular plate shape extends forward from the lower front end of the base body 63 and right and left screw holes 65 are formed in the horizontal plate 64. The base body 63 is fixed to the rear step surface 39 of the bottom wall 32 of the housing 26 by screwing setscrews 66 to the screw holes 65 of the horizontal plate 64, respectively.

As shown in FIG. 4, plural through holes 67, 68, and 69 (three through holes in this embodiment) are formed in the front wall of the base body 63 so as to extend in the up and down directions. Among the through holes 67 to 69, the central through hole 68 has such a height to be coaxial with the connection port 57 of the waste ink tank 27 attached to the attachment location 31 of the receiving chamber 30, when the base body 63 is fixed onto the rear step surface 39 of the bottom wall 32 of the housing 26. An inward flange 70 (see FIGS. 5A and 5B) is formed at an intermediate position in an axial direction of the inner circumferential surface of each of the upper through hole 67 and the lower through hole 69. In addition, a substantially U-shaped tube fixing portion 71 through which the flexible tube 43 is inserted to be supported is formed in the substantially central portion of the upper end of the front wall of the base body 63.

As shown in FIG. 4 and FIGS. 5A and 5B, a support member 72 linearly supporting the flexible tube 43 is assembled with the front surface of the base body 63. The support member 72 is a resin-molded product having rigidity, including a tubular body 73 as a main member which can be inserted into or detached from the connection port 57 of the waste ink tank 27, and having a predetermined length in the front and rear directions. A brim portion 74 having a rectangular plate shape is monolithically formed at a position closer to the rear side (base end side) than the center in an axial direction of the tubular body 73. In the support member 72, a base-end tubular portion (second support member) 75 protruding more rearward than the brim portion 74 of the tubular body 73 has an outer diameter smaller than the diameter of the intermediate through hole 68 of the base body 63 and an inner diameter into which the flexible tube 43 can be inserted.

On the other hand, in the support member 72, a predetermined length portion of the tubular body 73 serving as a second support portion in front of (on the front side) the brim portion 74 has an outer diameter slightly smaller than the width of the cut-in groove 62 of the third ink absorbing member 45c received in the waste ink tank 27 and a length almost equal to the distance from the rear edge of the third ink absorbing member 45c to the center of the through hole 61. In the predetermined length portion of the tubular body 73 in front of the brim portion 74, a relatively-long tubular portion from the front tubular portion 76 to the rear brim portion 74, except for the relatively-short front tubular portion 76 having a cylinder shape into which the front end as a downstream end of the flexible tube 43 is inserted, is formed as a non-tubular portion 77 in which about a half of the circumferential wall is cut out. In the inner surface of the non-tubular portion 77, insertion claws (fixing portions) 78 forming pairs protrude from plural positions (three positions in this embodiment) in the axial direction of the tubular body 73 so that the distance from the opposite insertion claw 78 is slightly smaller than the outer diameter of the flexible tube 43.

In the support member 72, when the base-side tubular portion 75 of the tubular body 73 is loosely inserted into the central through hole 68 of the base body 63, the front-side predetermined length portion including the front end (downstream end) of the flexible tube 43 inserted from the base-side opening of the base-side tubular portion 75 is supported by the front tubular portion 76 and the non-tubular portion 77. That is, the front tubular portion 76 in the tubular body 73 supports the front end of the flexible tube 43 in the inserted state since the inner diameter of the front tubular portion 76 is equal to the outer diameter of the flexible tube 43. In addition, the non-tubular portion 77 fixes the flexible tube 43 by inserting the flexible tube 43 from the side so that the fixing claws 78 fix the plural locations (three locations in this embodiment) of the portion extending from the front end to the base end of the flexible tube 43. Accordingly, the front-side predetermined length portion in the flexible tube 43 is supported by the tubular body 73 of the support member 72 so as to extend in a direction in which the front end of the flexible tube 43 is oriented.

A positioning pin 85 which can be inserted into or detached from the positioning hole 58a of the cylinder portion 58 of the waste ink tank 27 protrudes forward from the left edge of the front surface of the brim portion 74 of the support member 72. Likewise, a vertical plate portion 86 having a rectangular plate shape protrudes forward from a position below the positioning pin 85 in the left edge of the front surface of the brim portion 74. A connection terminal 87 corresponding to the connection terminal 59 formed on the sub left side wall 50b of the waste ink tank 27 is mounted on one surface (right surface) of the vertical plate portion 86. The connection terminal 87 is connected to a control unit (not shown) of the printer 11 through a harness (not shown).

On the other hand, a pair of upper and lower cylinders 79 that can be respectively inserted into the upper through hole 67 and the lower through hole 69 of the base body 63 protrudes in parallel backward from two upper and lower positions of the base-side tubular portion 75 in the rear surface of the brim portion 74 of the support member 72. In addition, the upper and lower cylinders 79 are respectively inserted into the upper through hole 67 and the lower through hole 69 of the base body 63 in a state where the cylinders 79 are put into coil springs 80 serving as an urging unit against the circumferential surfaces. In this case, the front ends of the coil springs 80 come in contact with the rear surface of the brim portion 74 of the support member 72 and the rear ends thereof come in contact with the flanges 70 formed at the middle positions of the inner circumferential surfaces of the upper through hole 67 and the lower through hole 69, respectively. Screw holes (not shown) are formed on the front end surfaces of the cylinders 79, respectively.

As shown in FIG. 4 and FIGS. 5A and 5B, an assembly plate 81 assembling the support member 72 into the base body 63 is disposed on the rear surface of the base body 63. The assembly plate 81 has a rectangular plate shape coming in contact with the rear surface of the front wall when the assembly plate 81 is disposed between both side walls of the base body 63 having the substantial ⊃ shape in a plan view. A through hole 82 corresponding to the central through hole 68 of the base body 63 is formed in the substantial center of the assembly plate 81. Screw insertion holes 83 are formed at two positions, which correspond to the upper though hole 67 and the lower through hole 69 of the base body 63, above and below the through hole 82 in the assembly plate 81. In addition, the assembly plate 81 is screwed to the cylinders 79 of the support member 72 of which the front ends protrude backward from the upper through hole 67 and the lower through hole 69 of the base body 63 with setscrews 84 inserted into the screw insertion holes 83.

A method of detaching the waste ink tank 27 from the printer 11 will be described now with reference to FIG. 2 again.

As shown in FIG. 2, when the waste ink tank 27 attached to the attachment location 31 in the receiving chamber 30 is detached from the printer 11, the door 36 of the attachment and detachment port 34 is opened and a user of the printer 11 puts his hand into the attachment and detachment port 34 and grasps the front end portion of the waste ink tank 27. Then, the user lifts up the front end portion of the waste ink tank 27 to incline the posture of the waste ink tank 27 and thus unlocks the locking stepped portion 40 from the locking stepped portion 60. In this state, since the urging force of the coil springs 80 acts on the waste ink tank 27 through the brim portion 74 of the support member 72 in the detachment direction (to the front side), the urging force assists the movement in the detachment direction and thus the waste ink tank 27 is easily detached through the attachment and detachment port 34.

A method of attaching the waste ink tank 27 to the printer 11 will be described now. Here, a new waste ink tank 27 may be a waste ink tank 27 of which the container member 44 is recycled as described later.

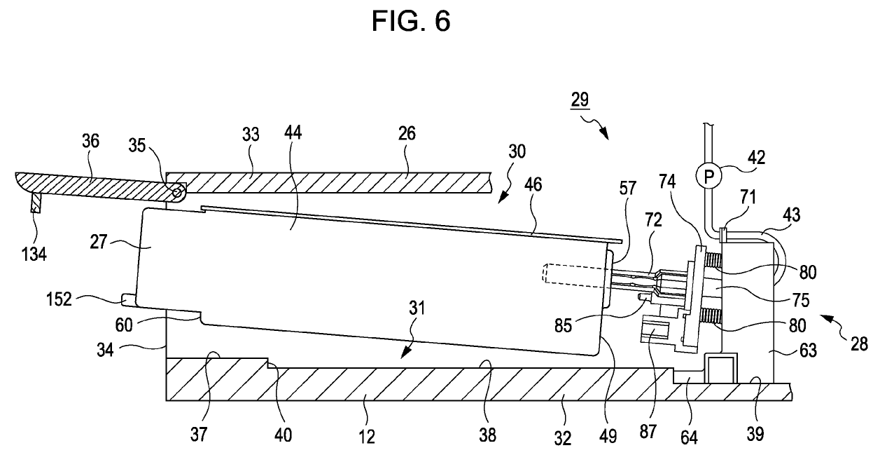

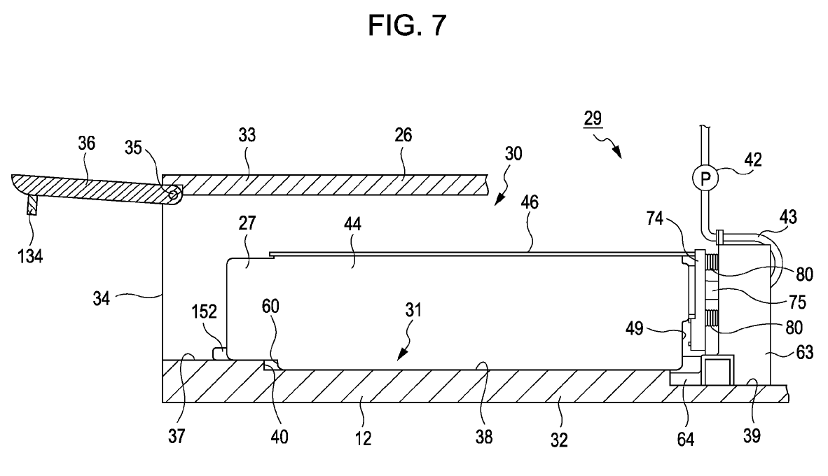

FIG. 6 is a partially-omitted sectional view (first) illustrating the inside of the receiving chamber at the time of detaching the waste ink tank 27. FIG. 7 is a partially-omitted sectional view (second) illustrating the inside of the receiving chamber at the time of detaching the waste ink tank.

When the waste ink tank 27 is attached to the attachment location 31 of the receiving chamber 30, first, the door 36 on the front surface of the housing 26 is opened. The waste ink tank 27 is inserted into the opened attachment and detachment port 34 from the rear end thereof where the connection port 57 is formed and the waste ink tank 27 is made to move to the rear side which is the attachment direction to the attachment location 31. Then, as shown in FIG. 6, in the front step where the entire waste ink tank 27 is inserted into the receiving chamber 30, the front tubular shape 76 of the tubular body 73 of the support member 72 in the tube supporting mechanism 28 is inserted into the connection port 57 of the main rear side wall 49a.

In the tube supporting mechanism 28 according to this embodiment, the front end of the support member 72 is pivotable about the base end thereof. Accordingly, when the front tubular portion 76 of the tubular body 73 is inserted into the connection port 57 of the waste ink tank 27 moving with its posture inclined, the support member 72 of the tube supporting mechanism 28 allows its front end to pivot to correspond to the inclination. Therefore, the front tubular portion 76 of the tubular body 73 in the support member 72 is inserted to the deep position of the connection port 57 of the waste ink tank 27 without interference.

When the waste ink tank 27 is made to further move toward the deep position of the receiving chamber 30 from the state shown in FIG. 6, the rear side wall 49 of the waste ink tank 27 comes in contact with the brim portion 74 of the support member 72 and the front tubular portion 76 of the tubular body 73 of the support member 72 reaches the position of the through hole 61 formed in the third ink absorbing member 45c. In this case, when the rear side wall 49 of the waste ink tank 27 comes in contact with the brim portion 74 of the support member 72, the positioning pin 85 protruding from the brim portion 74 of the support member 72 is inserted into the positioning hole 58a of the cylinder portion 58 disposed in the sub rear side wall 49b of the waste ink tank 27, whereby the waste ink tank 27 is positioned in the up and down directions and the right and left directions relative to the attachment location 31.

When the waste ink tank 27 is further pushed from this state so as to press the brim portion 74 of the support member 72, the support member 72 further retreats while further compressing the coil springs 80. When the brim portion 74 of the support member 72 retreats to the position closes to the front wall of the base body 63, as shown in FIG. 7, the waste ink tank 27 is changed to a horizontal posture and the bottom surface of the container member 44 in the waste ink tank 27 is brought into surface contact with the middle step surface 38 which is a part of the attachment location 31 in the receiving chamber 30. At this time, the locking stepped portion 60 formed on the bottom surface of the container member 44 of the waste ink tank 27 is located at a position in the receiving chamber 30 deeper than the locking stepped portion 40 formed at the attachment location 31 in the receiving chamber 30. In other words, at this time, the waste ink tank 27 departs from the attachment location 31 in the receiving chamber 30 in the attachment direction.

When the force (for example, the force of the user's hand) acting to move the waste ink tank 27 in the attachment direction is released from the state shown in FIG. 7, the brim portion 74 of the support member 72 goes forward with the urging force of the compressed coil springs 80 and thus the waste ink tank 27 is pressed to the front side (that is, in the detachment direction of the waste ink tank 27) by the brim portion 74. Then, the waste ink tank 27 slides forward over the middle step surface 38 of the attachment location 31 with the pressing force and the locking stepped portion 60 of the container member 44 is locked to the locking stepped portion 40 of the attachment location 31 as shown in FIG. 2. That is, the locking stepped portion 40 not lockable when the waste ink tank 27 moves in the attachment direction opposite to the detachment direction relative to the locking stepped portion 60 of the container member 44 serves as a locking unit regulating the movement in the detachment direction of the waste ink tank 27 when the waste ink tank 27 slides and moves in the detachment direction.

Accordingly, the urging force of the coil springs 80 is applied to the waste ink tank 27 from the rear side through the brim portion 74 of the support member 72 and the locking stepped portion 40 of the attachment location 31 is locked forward to the locking stepped portion 60 of the bottom surface of the container member 44, whereby the waste ink tank 27 is positioned at the attachment location 31 in the receiving chamber 30 to be immovable in the front and rear directions as shown in FIG. 2. Accordingly, the locking stepped portion 40 serving as the locking unit to the coil springs 80 as the urging unit serves as a holding unit holding the waste ink tank 27 at the attachment location 31, as shown in FIG. 2. When the door 36 of the attachment and detachment port 34 is returned to the closing location, the pressing member 134 presses the front protruding portion 152 from the upside so as to allow the waste ink tank not to move in the up and down directions. In this way, the attachment operation of the waste ink tank 27 to the attachment location 31 is finished.

A method of recycling the container member 44 according to this embodiment will be described now. As described above, when the waste ink tank 27 is used in the printer 11 and collects a predetermined amount of ink, the waste ink tank 27 is replaced. At this time, when the container member 44 of the waste ink tank 27 can be reused, it is not necessary to form a new container member 44, which is advantageous in view of environment and economy.

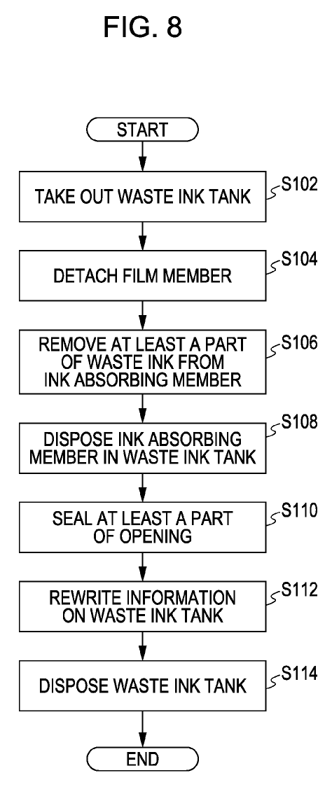

FIG. 8 is a flowchart illustrating the method of recycling the container member 44 according to this embodiment. The method of recycling the container member 44 will be described now with reference the flowchart.

First, the waste ink tank 27 is detached and recovered from the printer 11 (S102). The method of detaching the waste ink tank 27 is as described above. The waste ink tanks 27 of plural printers 11 may be recovered together. The container members 44 of the recovered waste ink tanks 27 may be reused together in a recycle plant.

The film member 46 is detached from the used waste ink tank 27 (S104). The detachment of the film member 46 is performed by allowing a person recycling the waste ink tank 27 to grasp an end of the film member 46 and to peel off the film member from the container member 44. The film member 46 was welded to the container member 44. Accordingly, the welded portion of the film member 46 may be heated again to facilitate the peeling of the film member 46 from the container member 44 and then the film member 46 may be detached. In this way, it is possible to reduce the remainder of the film member at the position to which the film member 46 is welded. When a part of the film member remains in the opening 48, the remaining may be shaved.

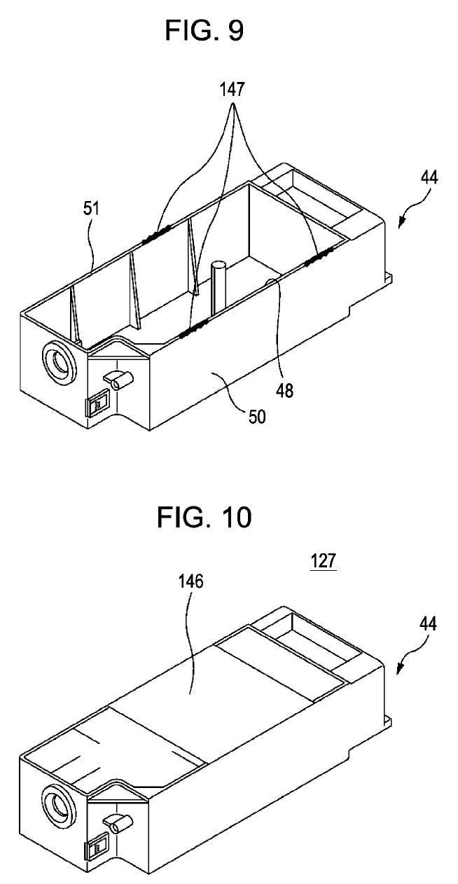

FIG. 9 is a diagram illustrating a state where a part 147 of the film member is attached to the periphery of the opening 48. When a part 147 of the film member remaining at the time of detaching the film member is attached to the periphery of the opening, a gap may be generated between the film member 46 and the container member 44 at the time of welding the film member 46 to the container member 44. Accordingly, it is preferable that the periphery of the opening 48 should be shaved to flatten the surface to which the film member 46 would be welded before sealing at least a part of the opening 48. Here, a part 147 of the film member remaining around the opening 48 is shaved. Accordingly, the opening is flattened.

The ink absorbing members 45a to 45d are taken out of the waste ink tank 27 and at least a part of the waste ink is removed from the ink absorbing members 45a to 45d (S106). The removal of the waste ink can be carried out by cleaning the ink absorbing members 45a to 45d. At this time, the ink absorbing members 45a to 45d may be cleaned using a detergent or may be cleaned using a solvent.

The absorbed waste ink may be removed from the ink absorbing members 45a to 45d by squeezing the ink absorbing members 45a to 45d. The absorbed waste ink may be removed by wiping the ink absorbing members 45a to 45d.

After the waste ink tank 27 is detached from the printer 11 in step S102, the waste ink absorbed by the ink absorbing members 45a to 45d may be removed while cleaning the waste ink tank 27 as a whole. In this case, the film member 46 may not be detached. The waste ink tank 27 may be cleaned as a whole after the connection terminal 59 is demounted. Accordingly, it is possible to omit a process of detaching and then sealing again the film member 46 or a process of extracting and receiving again the ink absorbing members 45a to 45d.

When the ink absorbing members 45a to 45d are extracted and cleaned, the ink absorbing members 45a to 45d from which at least a part of the waste ink is removed are received again in the container member 44 (S108). In the order of receiving the ink absorbing members 45a to 45d, as shown in FIG. 3, the ink absorbing member 45a is received on the bottom of the container member 44 and then the ink absorbing members 45b to 45d are sequentially stacked and received in the container member 44.

When the ink absorbing members 45a to 45d are received again in the container member 44, the ink absorbing member 45d may be received on the bottom of the container member 44 and the ink absorbing member 45a may be received on the upper portion of the container member 44. It is considered that one of the used ink absorbing members 45a to 45d received closer to the bottom of the container member 44 absorbs more waste ink. It is also considered that although a part of the waste ink is removed, the ink absorbing member located lower and having absorbed more waste ink has such an amount of waste ink not to be cleaned.

Therefore, the ink absorbing member 45d received in the upper portion of the container member 44 may be received on the bottom after cleaning. The ink absorbing member 45a received on the bottom of the container member 44 may be received in the uppermost portion after cleaning. Accordingly, since the ink absorbing member from which the waste ink is more removed can be disposed on the lower portion where more waste ink is collected, it is possible to absorb more waste ink after recycling.

Although it is described above that all the cleaned ink absorbing members 45a to 45d are returned to the container member 44, at least one of the ink absorbing member 45a to 45d may be replaced with a non-used ink absorbing member and may be received in the container member 44. For example, the first ink absorbing member 45a considered as absorbing the most ink may be replaced with a non-used ink absorbing member. The replaced non-used ink absorbing member may have an outer shape different from the outer shapes of the ink absorbing members 45a to 45d.

In this case, some ink absorbing members hardly absorbing waste ink can be replaced with non-used ink absorbing members to recycle the waste ink tank capable of collecting more waste ink.

In this way, when the ink absorbing members are received in the container member 44, at least a part of the opening 48 is sealed (S110).

FIG. 10 is a diagram illustrating a state where the film member 146 is welded to a part of the opening 48. In the drawing, a recycled waste ink tank 127 to which the film member 146 is welded is shown. At the time of recycling the container member 44, as shown in the drawing, the film member 146 may be thermally welded and attached to only a part of the opening 48. In this case, it can be determined from the non-sealed portion whether the recycled waste ink tank 127 is a recycled product or a new product. By sealing only a part of the opening 48, it is not necessary to form the air hole 113 in the film member.

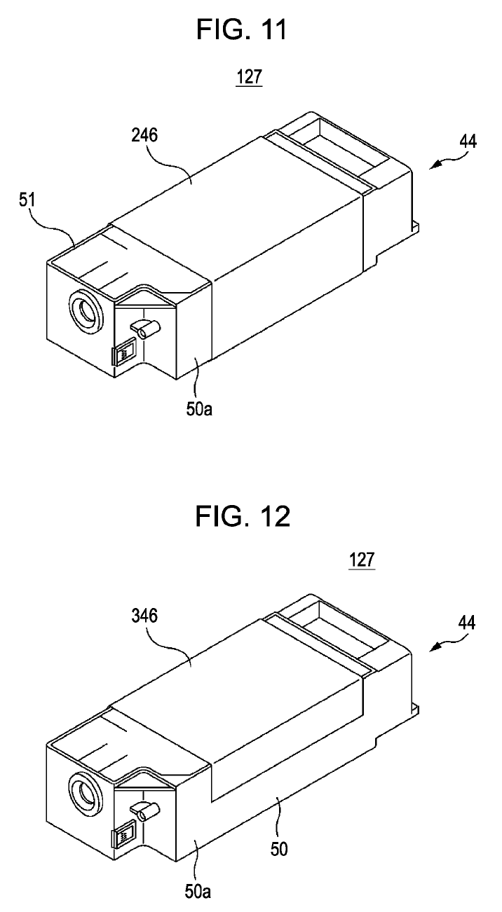

FIG. 11 is a diagram illustrating a state where the container member 44 is wound by the film member 246. In the drawing, a recycled waste ink tank 127 to which a film member 248 is attached is shown. At the time of sealing at least a part of the opening 48, as shown in the drawing, the film member 246 may be wound around the container member 44 so as to seal at least a part of the opening 48. The end of the film member 246 may be fixed with an adhesive. By attaching the film member 246 in this way, the film member 246 can be easily attached to the container member 44 even when a part of the old film member remains around the opening 48. It is possible to easily seal at least a part of the opening 48. A food wrapping film may be used as the film member 246 wound on the container member 44.

FIG. 12 is a diagram illustrating a state where a film member 346 is attached using a side wall of the container member 44. In the drawing, a recycled waste ink tank 127 to which the film member 346 is attached is shown. At the time of sealing at least a part of the opening 48, as shown in the drawing, end portions of the film member 346 may be bonded to the side walls 50 and 51 of the container member 44. By attaching the film member 346 in this way, the film member 346 can be easily attached to the container member 44 even when a part of the old film member remains around the opening 48.

FIG. 13 is a sectional view illustrating a state where a lid member 446 is attached to at least a part of the opening 48 of the container member 44. In the drawing, a section of a recycled waste ink tank 127 to which the lid member 446 is attached is shown. As shown in the drawing, at the time of sealing at least a part of the opening 48, the lid member 446 fitted to the top portions of the side walls 50 and 51 of the container member 44 may be attached. By providing the lid member 446, it is possible to easily extract the ink absorbing members from the opening 48 at the time of recycling the container member 44.

Although at least a part of the opening 48 is sealed in step S110, the container member 44 receiving the ink absorbing members without sealing the opening 48 may be used as the recycled waste ink tank 127. In this case, the processes of steps S112 to S114 described below may be performed without performing the process of step S110 in FIG. 8. The sealing of at least a part of the opening 48 includes sealing the entire opening 48 as shown in FIG. 3.

When a part of the opening 48 is sealed, the sealed part of the opening 48 is preferably a portion above the through hole 61. In this case, since the discharged waste ink is suppressed from immediate vaporization, the ink absorbing members do not clog in the vicinity of the through hole 61 and thus the waste ink can easily diffuse into the ink absorbing members as a whole. In addition, since the waste ink is vaporized from the non-covered portion of the opening 48, a more amount of waste ink can be collected. Accordingly, it is preferable that the non-covered portion of the opening 48 is apart from the discharge portion. However, when ink can diffuse as a whole in spite of the vaporization thereof, the sealed part is not particularly limited.

In this way, when the opening 48 of the container member 44 is sealed, information on the waste ink tank is then rewritten to the circuit board of the connection terminal 59 (S112).

The circuit board is formed in the connection terminal 59. The circuit board includes an EPROM (Erasable Programmable ROM) which information can be erased from and written to and stores a variety of information on the waste ink tank 127. For example, the number of reusable times of the container member 44, the amount of collectable ink of the waste ink tank, and the manufacturing date of the waste ink tank are stored in the circuit board.

The amount of collectable ink is predetermined for the waste ink 127. Accordingly, whenever the waste ink is discharged to the waste ink tank 127, the printer 11 counts the amount of discharged ink, subtracts the amount of discharge ink from the amount of collectable ink stored in the circuit board, and rewrites the result. Therefore, by allowing the circuit board to store the amount of collectable ink, the printer 11 can monitor the amount of collectable ink of the waste ink tank 127 so that the amount of discharged ink should not exceed the amount of collectable ink.

At the time of recycling the waste ink tank 127, the stored amount of collectable ink can be rewritten to the circuit board so as to be the amount of collectable ink of a non-used waste ink tank 127. For example, when the amount of collectable ink of the waste ink tank is reduced to 0 g by use, the amount of collectable ink is rewritten to the circuit board as 60 g which is the amount of collectable ink of a non-used waste ink tank.

Since the recycled waste ink tank 127 is a recycled product, a smaller amount of collectable ink may be rewritten. For example, 60 g is written to the circuit board as the amount of collectable ink of a new waste ink tank 127, but 50 g may be rewritten as the amount of collectable ink to the circuit board of the recycled waste ink tank 127.

The number of reusable times of the container member 44 may be stored in the circuit board and the number of reusable times of the container member 44 may be reduced and stored in the circuit board when ever the waste ink tank 127 is recycled. Accordingly, it is possible to know the lifetime of the container member 44. For the following reason, it is necessary to know the lifetime of the container member 44.

As described above, at the time of recycling the container member 44, the welding surface of the film member may be shaved. Then, the amount of shaved portion increases with the increase of the number of reused times and thus the height of the container member 44 may be reduced. In this case, there is a problem in that the ink absorbing member having an expected size may not be received or only an amount of waste ink smaller than an expected amount of collectable ink can be collected. Accordingly, the number of reused times of the container member 44 is stored in the circuit board to know the lifetime of the container member 44.

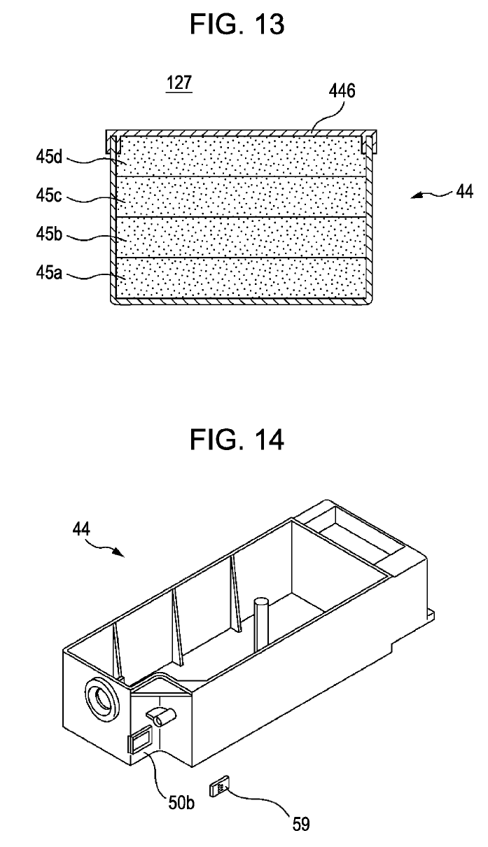

FIG. 14 is a diagram illustrating a state where the connection terminal 59 is demounted from the container member 44. In this way, at the time of updating the details stored in the circuit board 59a, the connection terminal 59 may be demounted from the container member 44. The connection terminal 59 may be demounted from the container member 44 and then a new connection terminal may be mounted thereon.

As described above, when the waste ink tank 127 is recycled reusing the container member 44, the recycled waste ink tank 127 is attached to the printer 11 (S114). Since the recycled waste ink tank 127 is manufactured using the container member 44, the outer shape thereof is almost the same as the old waste ink tank 27. Accordingly, the recycled waste ink tank can be attached to the printer 11, similarly to the old waste ink tank 27.

The processes of steps S104 to S112 may be performed by a person other than the user.

Other modifications of the first embodiment of the invention will be described now.

Although an ink jet printer is embodied as a fluid ejecting apparatus having the recycled waste liquid collector (waste ink tank) reusing the container member in the above-mentioned embodiment, the invention may be applied to a fluid ejecting apparatus spraying or ejecting a liquid (including a liquid-like material in which particles of a functional material are dispersed and a colloidal material such as gel, in addition to the liquid) other than the ink or a fluid (such as solid that can be made to flow and ejected as a fluid) other than the liquid. For example, the fluid ejecting apparatus may be a liquid-like material ejecting apparatus ejecting a liquid-like material in which materials such as an electrode material or a coloring material used for manufacturing a liquid crystal display, an electroluminescence (EL) display, and a surface-emission display are dispersed or melted, a liquid ejecting apparatus ejecting bio organics used for manufacturing a bio chip, or a liquid ejecting apparatus used as a precise pipette to eject a liquid as a sample. In addition, the fluid ejecting apparatus may be a liquid ejecting apparatus ejecting lubricant to a precise machine such as a clock or a camera by the use of a pin point, a liquid ejecting apparatus ejecting a transparent resin liquid such as a UV-curable resin onto a substrate to form a micro semi-circular lens (optical lens) used in an optical communication device, a liquid ejecting apparatus ejecting etchant such as acid or alkali to etch a substrate and the like, a colloidal material ejecting apparatus ejecting such as gel, or a powder-ejecting recording apparatus ejecting a solid such as toner powder. The invention can be applied to one of the above-mentioned ejecting apparatuses.

In this embodiment, the ink includes aqueous ink and oily ink.

The above-mentioned embodiment is intended for easy understanding of the invention, but not for definitely analyzing the invention. The invention can be modified and improved without departing from the gist thereof and equivalents thereof can be included in the invention. The embodiments are also included in the invention.

Hereinafter, a second embodiment of the invention will be described.

FIG. 1 is a perspective view illustrating an ink jet printer according to the first embodiment of the invention. FIG. 2 is a partially-omitted sectional view illustrating a housing in the printer. FIG. 3 is an exploded perspective view illustrating a waste ink tank. FIG. 4 is an exploded perspective view illustrating a tube supporting mechanism. FIG. 5A is a partially-exploded front view illustrating the tube supporting mechanism and FIG. 5B is a partially-exploded front view illustrating the tube supporting mechanism in a state where a support member retreats.

Hereinafter, a waste liquid collecting system in an ink jet printer which is a kind of liquid ejecting apparatus will be described with reference to the drawings. “Front and rear directions”, “up and down directions”, and “right and left directions” in the following description means “front and rear directions”, “up and down directions”, and “right and left directions” indicated by arrows in FIGS. 1 to 4.

As shown in FIG. 1, an ink jet printer (hereinafter, referred to as “printer”) 11 as a liquid ejecting apparatus according to this embodiment includes a frame 12 having a rectangular shape in a plan view.

A transport roller 13 extends in the right and left directions in the frame 12. A printing sheet P is fed from the rear side to the front side by allowing the transport roller 13 to rotate by the use of a sheet feeding motor 14. In addition, a guide shaft 15 extending in parallel to a longitudinal direction (the right and left directions) of the transport roller 13 is disposed above the transport roller 13 in the frame 12.

A carriage 16 is supported by the guide shaft 15 so as to reciprocate along an axial line direction (the right and left directions) of the guide shaft 15. A driving pulley 17 and a driven pulley 18 are rotatably supported at positions corresponding to both ends of the guide shaft 15 in the rear surface of the frame 12, respectively. A carriage motor 19 serving as a driving source for allowing the carriage 16 to reciprocate is connected to the driving pulley 17. A timing belt 20 fixing and supporting the carriage 16 is suspended between the pair of pulleys 17 and 18. Accordingly, the carriage 16 moves in the right and left directions through the timing belt 20 by the carriage motor 19 while being guided by the guide shaft 15.

As shown in FIG. 1, a print head 21 as a liquid ejecting head is disposed on the lower surface of the carriage 16. On the other hand, plural ink cartridges 23 for supplying ink as a liquid to the print head 21 are detachably mounted on the carriage 16. The ink cartridges 23 individually correspond to plural nozzle opening lines (not shown) formed in a nozzle formation surface 21a (see FIG. 2) which is the lower surface of the print head 21 and individually supply ink to the corresponding nozzle opening lines through ink passages (not shown) formed in the print head 21.

A home position HP serving as a maintenance position where the carriage 16 is located at the time of turning off the printer 11 or maintaining the print head 21 is disposed in one end (the right end in FIG. 1) in the frame 12, that is, in a non-printing area which the printing sheet P does not reach. In addition, a maintenance unit 24 performing various maintenance operations is disposed below the home position HP so as to satisfactorily eject ink to the printing sheet P from the print head 21.

The maintenance unit 24 includes a cap 25 having a substantially rectangular shape corresponding to the lower surface (the nozzle formation surface) of the print head 21 and an elevation mechanism (not shown) moving the cap 25 up and down. In addition, when the cap 25 moves up by the driving of the elevation mechanism (not shown) with the carriage 16 located at the home position HP, the cap 25 comes in contact with the nozzle formation surface 21a which is the lower surface of the print head 21 so as to surround the nozzle opening lines.

As shown in FIGS. 1 and 2, a housing 26 having a rectangular parallelepiped shape in the front and rear directions is formed at one end (the right end in FIG. 1) in the frame 12 and below the home position HP. A receiving chamber 30 receiving a waste liquid collecting system 29 including a waste ink tank 27 as a waste liquid collector and a tube supporting mechanism 28 as a liquid passage forming unit is formed in the housing 26. An attachment location 31 of the waste ink tank 27 is set in a lower portion of the receiving chamber 30. As shown in FIG. 2, the height (which is a distance between a bottom wall 32 and a top wall 33) of the receiving chamber 30 is set sufficiently higher than the height of the waste ink tank 27 so that the waste ink tank 27 can be tilted inside the receiving chamber 30.

When the cap 25 moves up from the state shown in FIG. 2 by the driving of the elevation mechanism (not shown) and comes in contact with the nozzle formation surface 21a of the print head 21, a suction pump 42 is driven. Then, the thickened ink in the print head 21 is forcibly sucked and discharged (ejected) as waste ink into the cap 25 through nozzle openings (not shown) by a negative pressure generated in the cap 25. When an idle suction state of sucking the atmospheric air is reached by exposing the inside of the cap 25 to the atmospheric air in a state where the suction pump 42 is being driven, the waste ink is discharged from the cap 25 to the waste ink tank 27.

A rectangular attachment and detachment port 34 through which the waste ink tank 27 passes upon attaching or detaching the waste ink tank 27 to or from the attachment location 31 in the receiving chamber 30 is formed on the front surface of the housing 26. A door 36 of which the upper end portion is rotatably supported on a pair of right and left shafts 35 formed at both ends of the upper edge of the attachment and detachment port 34 is disposed in the attachment and detachment port 34. By grasping a knob 36a formed on the front surface of the door 36 and opening or closing the door 36 about the shafts 35, the door 36 moves between a closing location indicated by a solid line and an opening location indicated a two-dot chain line in FIG. 2.

A pressing member 134 pressing a front protruding portion 152 of the waste ink tank 27 from the upside is formed monolithically with the door 36. Accordingly, it is possible to prevent the front side of the waste ink tank 27 from floating, by closing the door 36.

As shown in FIG. 2, in the receiving chamber 30 of the housing 26, a front step surface 37, a middle step surface 38, and a rear step surface 39 are formed in a step shape on the upper surface of the bottom wall 32 from the front side to the rear side in the front and rear directions. The front step surface 37 has the same height as the lower edge of the attachment and detachment port 34. A locking step 40 as a locking portion making the middle step surface 38 lower than the front step surface 37 is formed between the rear end of the front step surface 37 and the front end of the middle step surface 38 so as to extend in the right and left directions.

The middle step surface 38 has a length in the front and rear directions slightly smaller than the length of the waste ink tank 27 in the front and rear directions. The almost entire area of the middle step surface 38 and the rear half area of the front step surface 37 form the attachment location 31 of the waste ink tank 27. The rear step surface 39 is slightly lower than the middle step surface 38 with a stepped portion 41 interposed therebetween. The tube supporting mechanism 28 supporting a flexible tube 43, which discharges the ink forcibly sucked as the waste ink (waste liquid) from the cap 25 to the waste ink tank 27 by the driving of the suction pump 42, is disposed on the rear step surface 39.

The waste ink tank 27 will be described now. As shown in FIG. 3, the waste ink tank 27 includes a container member 44 having a bottomed box shape of which the top is opened, plural ink absorbing members (waste liquid absorbing members) 45a to 45d having an outer shape corresponding to the opening shape of the container member 44, and a film member 46 as a gas-liquid non-transmitting member having an outer shape corresponding to the opening shape of the container member 44. The inside of the container member 44 serves as a receiving space 47 and the ink absorbing members 45a to 45d are stacked and received in the receiving space 47. The opening 48 of the container member 44 is sealed by bonding (welding in this embodiment) the film member 46 to the container member 44 to cover the opening 48 of the container member 44 having received the ink absorbing members 45a to 45d are received. An air hole 113 is formed at a position of the film member 46 bonded to the container member 44. As described above, the front protruding portion 152 is formed in the container member 44 so as to extend in the right and left directions.

Ribs 52 having a thin plate shape are formed in the up and down directions in the inner surface of a rear side wall 49 of the container member 44. Similarly, ribs 52b having a thin plate shape are formed in the up and down directions on right and left side walls 50 and 51. Only one rib 52a on the rear side wall 49 and three ribs 52b on the right side wall 51 are shown in FIG. 3. In addition, cut-in portions 53 are formed in the outer edges of the ink absorbing members 45a to 45d so as to correspond to the positions of the ribs 52a and 52b.

A columnar post 54 is formed upright at a position slightly closer to the front than the center of the bottom surface of the container member 44. Round holes 55 are formed upright at a position slightly closer to the front than the center of the ink absorbing members 45 so as to correspond to the post 54. The corresponding ribs 52a and 52b are inserted into the cut-in portions 53 and the post 54 is inserted into the holes 55, whereby the ink absorbing members 45a to 45d are stacked and received in the receiving space 47 of the container member 44.

As shown in FIG. 3, a concave portion 56 is formed in the rear-left corner of the container member 44. As a result, the rear side wall 49 is divided into a main rear side wall 49a located on the relative rear side and a sub rear side wall 49b located on the relative front side and the left side wall 50 is divided into a main left side wall 50a located on the relative left side and a sub left side wall 50b located on the relative right side.

A round connection port 57 is formed in the main rear side wall 49a. The connection port 57 has a diameter which gradually decreases from the opening edge to a deep side and has a function of guiding a member to a deep center of the connection port 57 when the member inserted into the connection port 57 from the outside comes in contact with the inner circumferential surface of the connection port 57 in the front and rear directions. Specifically, since the inner circumferential surface of the connection port 57 in the waste ink tank 27 is a tapered surface of which the diameter decreases to the deep side of the connection port 57, a tubular body 73 of a support member 72 to be described later is slidably guided to the center of the connection port 57 as it is inserted into the connection port 57.

The shape of the connection port 57 is not limited to the round shape. The connection port 57 may have, for example, a triangular shape, a polygonal shape, or an elliptical shape. In the drawing, the connection port 57 protrudes more than the rear side wall 49, but may be formed not to protrude.

A cylinder portion 58 protrudes to the rear side from the sub rear side wall 49b and the hole of the cylinder portion 58 forms a positioning hole 58a. As described later, a positioning pin 85 protruding from a brim portion 74 of the support member 72 is inserted into the positioning hole 58a of the cylinder portion 58. Accordingly, the positioning pin 85 and the positioning hole 58a serve as a holding unit holding the waste ink tank 27 to regulate the movement thereof in the up and down directions and the right and left directions at the attachment location 31.

When the shape of the positioning pin 85 is not cylindrical, the shape of the positioning hole 58a may not be cylindrical. For example, when the outer shape of the positioning pin 85 is rectangular, the positioning hole 58a may be a hole having a concave portion into which the pin is inserted. When the positioning pin 85 is a simple plate-like member, the positioning hole 58a may be a plate-like member capable of coming in contact with the pin to position the pin.

A connection terminal 59 having a circuit board storing various information of the waste ink tank 27 to be described later is mounted on the outer surface of the sub left side wall 50b. A locking stepped portion 60 engaging with the locking stepped portion 40 formed on the bottom wall 32 of the housing 26 in the front and rear directions is formed at a position slightly closer to the rear end than the front end of the bottom surface of the container member 44 so as to extend in the right and left directions.

As shown in FIG. 3, among the ink absorbing members 45a to 45d, the lowermost first ink absorbing member 45a and the uppermost fourth ink absorbing member 45d have the same thickness and the same shape and the second ink absorbing member 45b stacked as the second layer from the bottom and the third ink absorbing member 45c stacked as the third layer from the bottom have the same thickness. A through-hole 61 having a square shape is formed in a position slightly closer to the rear side than the center in each of the second ink absorbing member 45b and the third ink absorbing member 45c. A cut-in groove 62 having a predetermined width is formed in the third ink absorbing member 45c in the front and rear directions from the rear edge to the through hole 61.

As shown in FIG. 3, the first ink absorbing member 45a stops the through hole 61 from the downside and the fourth ink absorbing member 45d stops the through hole 61 from the upside. When a front tubular portion 76 is inserted into the cut-in groove 62, the waste ink discharged from the front tubular portion 76 drops on the top surface of the first ink absorbing member 45a and is absorbed therein. As the amount of waste ink absorbed increases, the waste ink slowly diffuses from the first ink absorbing member 45a to the upper ink absorbing members.

Here, when the amount of waste ink is great, the waste ink cannot diffuse into the first ink absorbing member 45a. Accordingly, the through hole 61 temporarily stores the waste ink. That is, the discharged waste ink is stored until the waste ink is absorbed by the ink absorbing members (the waste ink diffuses into the ink absorbing members). Therefore, it is preferable that the through hole 61 has such a size to contain the discharged waste ink. When the container member 44 is detached and the posture of the container member 44 is upside-down in the state where the through hole 61 stores the waste ink, the fourth ink absorbing member 45d absorbs the waste ink stored in the through hole 61 to prevent the ink from leaking to the outside of the container member 44. The fourth ink absorbing member 45d suppresses the discharged waste ink from vaporization. When the waste ink is vaporized, the ink absorbing member clogs due to the thickened ink and thus the waste ink discharged later hardly diffuses therein. The fourth ink absorbing member 45d stops the through hole 61 to suppress the waste ink from vaporization from the top surface of the first ink absorbing member 45a onto which the discharged waste ink drops and is located above the ink absorbing members 45a, 45b, and 45c to suppress the waste ink from vaporization from the three ink absorbing members.

The waste ink tank 27 is constructed as described above. The ink absorbing members may be received in the container member 44 in a manner different from the above description. Similarly to the recycled waste ink tank 127 to be described later, the sealing member may seal at least a part of the opening of the container member 44 in a manner different from the above description.

The tube supporting mechanism 28 will be described now. As shown in FIG. 4 and FIGS. 5A and 5B, the tube supporting mechanism 28 includes a base body 63 having a substantial ⊃ shape in a plan view in which a front end distance between both side walls having a rectangular shape is constant and in which the front ends of both side walls are connected to each other with a rectangular front wall. A horizontal plate 64 having a rectangular plate shape extends forward from the lower front end of the base body 63 and right and left screw holes 65 are formed in the horizontal plate 64. The base body 63 is fixed to the rear step surface 39 of the bottom wall 32 of the housing 26 by screwing setscrews 66 to the screw holes 65 of the horizontal plate 64, respectively.

As shown in FIG. 4, plural through holes 67, 68, and 69 (three through holes in this embodiment) are formed in the front wall of the base body 63 so as to extend in the up and down directions. Among the through holes 67 to 69, the central through hole 68 has such a height to be coaxial with the connection port 57 of the waste ink tank 27 attached to the attachment location 31 of the receiving chamber 30, when the base body 63 is fixed onto the rear step surface 39 of the bottom wall 32 of the housing 26. An inward flange 70 (see FIGS. 5A and 5B) is formed at an intermediate position in an axial direction of the inner circumferential surface of each of the upper through hole 67 and the lower through hole 69. In addition, a substantially U-shaped tube fixing portion 71 through which the flexible tube 43 is inserted to be supported is formed in the substantially central portion of the upper end of the front wall of the base body 63.

As shown in FIG. 4 and FIGS. 5A and 5B, a support member 72 linearly supporting the flexible tube 43 is assembled with the front surface of the base body 63. The support member 72 is a resin-molded product having rigidity, including a tubular body 73 as a main member which can be inserted into or detached from the connection port 57 of the waste ink tank 27, and having a predetermined length in the front and rear directions. A brim portion 74 having a rectangular plate shape is monolithically formed at a position closer to the rear side (base end side) than the center in an axial direction of the tubular body 73. In the support member 72, a base-end tubular portion (second support member) 75 protruding more rearward than the brim portion 74 of the tubular body 73 has an outer diameter smaller than the diameter of the intermediate through hole 68 of the base body 63 and an inner diameter into which the flexible tube 43 can be inserted.

On the other hand, in the support member 72, a predetermined length portion of the tubular body 73 serving as a second support portion in front of (on the front side) the brim portion 74 has an outer diameter slightly smaller than the width of the cut-in groove 62 of the third ink absorbing member 45c received in the waste ink tank 27 and a length almost equal to the distance from the rear edge of the third ink absorbing member 45c to the center of the through hole 61. In the predetermined length portion of the tubular body 73 in front of the brim portion 74, a relatively-long tubular portion from the front tubular portion 76 to the rear brim portion 74, except for the relatively-short front tubular portion 76 having a cylinder shape into which the front end as a downstream end of the flexible tube 43 is inserted, is formed as a non-tubular portion 77 in which about a half of the circumferential wall is cut out. In the inner surface of the non-tubular portion 77, insertion claws (fixing portions) 78 forming pairs protrude from plural positions (three positions in this embodiment) in the axial direction of the tubular body 73 so that the distance from the opposite insertion claw 78 is slightly smaller than the outer diameter of the flexible tube 43.

In the support member 72, when the base-side tubular portion 75 of the tubular body 73 is loosely inserted into the central through hole 68 of the base body 63, the front-side predetermined length portion including the front end (downstream end) of the flexible tube 43 inserted from the base-side opening of the base-side tubular portion 75 is supported by the front tubular portion 76 and the non-tubular portion 77. That is, the front tubular portion 76 in the tubular body 73 supports the front end of the flexible tube 43 in the inserted state since the inner diameter of the front tubular portion 76 is equal to the outer diameter of the flexible tube 43. In addition, the non-tubular portion 77 fixes the flexible tube 43 by inserting the flexible tube 43 from the side so that the fixing claws 78 fix the plural locations (three locations in this embodiment) of the portion extending from the front end to the base end of the flexible tube 43. Accordingly, the front-side predetermined length portion in the flexible tube 43 is supported by the tubular body 73 of the support member 72 so as to extend in a direction in which the front end of the flexible tube 43 is oriented.

A positioning pin 85 which can be inserted into or detached from the positioning hole 58a of the cylinder portion 58 of the waste ink tank 27 protrudes forward from the left edge of the front surface of the brim portion 74 of the support member 72. Likewise, a vertical plate portion 86 having a rectangular plate shape protrudes from a position below the positioning pin 85 in the left edge of the front surface of the brim portion 74. A connection terminal 87 corresponding to the connection terminal 59 formed on the sub left side wall 50b of the waste ink tank 27 is mounted on one surface (right surface) of the vertical plate portion 86. The connection terminal 87 is connected to a control unit (not shown) of the printer 11 through a harness (not shown).

On the other hand, a pair of upper and lower cylinders 79 that can be respectively inserted into the upper through hole 67 and the lower through hole 69 of the base body 63 protrudes in parallel backward from two upper and lower positions of the base-side tubular portion 75 in the rear surface of the brim portion 74 of the support member 72. In addition, the upper and lower cylinders 79 are respectively inserted into the upper through hole 67 and the lower through hole 69 of the base body 63 in a state where the cylinders 79 are put into coil springs 80 serving as an urging unit against the circumferential surfaces. In this case, the front ends of the coil springs 80 come in contact with the rear surface of the brim portion 74 of the support member 72 and the rear ends thereof come in contact with the flanges 70 formed at the middle positions of the inner circumferential surfaces of the upper through hole 67 and the lower through hole 69, respectively. Screw holes (not shown) are formed on the front end surfaces of the cylinders 79, respectively.

As shown in FIG. 4 and FIGS. 5A and 5B, an assembly plate 81 assembling the support member 72 into the base body 63 is disposed on the rear surface of the base body 63. The assembly plate 81 has a rectangular plate shape coming in contact with the rear surface of the front wall when the assembly plate 81 is disposed between both side walls of the base body 63 having the substantial ⊃ shape in a plan view. A through hole 82 corresponding to the central through hole 68 of the base body 63 is formed in the substantial center of the assembly plate 81. Screw insertion holes 83 are formed at two positions, which correspond to the upper though hole 67 and the lower through hole 69 of the base body 63, above and below the through hole 82 in the assembly plate 81. In addition, the assembly plate 81 is screwed to the cylinders 79 of the support member 72 of which the front ends protrude backward from the upper through hole 67 and the lower through hole 69 of the base body 63 with setscrews 84 inserted into the screw insertion holes 83.

A method of detaching the waste ink tank 27 from the printer 11 will be described now with reference to FIG. 2 again.

As shown in FIG. 2, when the waste ink tank 27 attached to the attachment location 31 in the receiving chamber 30 is detached from the printer 11, the door 36 of the attachment and detachment port 34 is opened and a user of the printer 11 puts his hand into the attachment and detachment port 34 and grasps the front end portion of the waste ink tank 27. Then, the user lifts up the front end portion of the waste ink tank 27 to incline the posture of the waste ink tank 27 and thus unlocks the locking stepped portion 40 from the locking stepped portion 60. In this state, since the urging force of the coil springs 80 acts on the waste ink tank 27 through the brim portion 74 of the support member 72 in the detachment direction (to the front side), the urging force assists the movement in the detachment direction and thus the waste ink tank 27 is easily detached through the attachment and detachment port 34.

A method of attaching the waste ink tank 27 to the printer 11 will be described now. Here, a new waste ink tank 27 may be a waste ink tank 27 of which the container member 44 is recycled as described later.

FIG. 6 is a partially-omitted sectional view (first) illustrating the inside of the receiving chamber at the time of detaching the waste ink tank 27. FIG. 7 is a partially-omitted sectional view (second) illustrating the inside of the receiving chamber at the time of detaching the waste ink tank.

When the waste ink tank 27 is attached to the attachment location 31 of the receiving chamber 30, first, the door 36 on the front surface of the housing 26 is opened. The waste ink tank 27 is inserted into the opened attachment and detachment port 34 from the rear end thereof where the connection port 57 is formed and the waste ink tank 27 is made to move to the rear side which is the attachment direction to the attachment location 31. Then, as shown in FIG. 6, in the front step where the entire waste ink tank 27 is inserted into the receiving chamber 30, the front tubular shape 76 of the tubular body 73 of the support member 72 in the tube supporting mechanism 28 is inserted into the connection port 57 of the main rear side wall 49a.

In the tube supporting mechanism 28 according to this embodiment, the front end of the support member 72 is pivotable about the base end thereof. Accordingly, when the front tubular portion 76 of the tubular body 73 is inserted into the connection port 57 of the waste ink tank 27 moving with its posture inclined, the support member 72 of the tube supporting mechanism 28 allows its front end to pivot to correspond to the inclination. Therefore, the front tubular portion 76 of the tubular body 73 in the support member 72 is inserted to the deep position of the connection port 57 of the waste ink tank 27 without interference.

When the waste ink tank 27 is made to further move toward the deep position of the receiving chamber 30 from the state shown in FIG. 6, the rear side wall 49 of the waste ink tank 27 comes in contact with the brim portion 74 of the support member 72 and the front tubular portion 76 of the tubular body 73 of the support member 72 reaches the position of the through hole 61 formed in the third ink absorbing member 45c. In this case, when the rear side wall 49 of the waste ink tank 27 comes in contact with the brim portion 74 of the support member 72, the positioning pin 85 protruding from the brim portion 74 of the support member 72 is inserted into the positioning hole 58a of the cylinder portion 58 disposed in the sub rear side wall 49b of the waste ink tank 27, whereby the waste ink tank 27 is positioned in the up and down directions and the right and left directions relative to the attachment location 31.

When the waste ink tank 27 is further pushed from this state so as to press the brim portion 74 of the support member 72, the support member 72 further retreats while further compressing the coil springs 80. When the brim portion 74 of the support member 72 retreats to the position closest to the front wall of the base body 63, as shown in FIG. 7, the waste ink tank 27 is changed to a horizontal posture and the bottom surface of the container member 44 in the waste ink tank 27 is brought into surface contact with the middle step surface 38 which is a part of the attachment location 31 in the receiving chamber 30. At this time, the locking stepped portion 60 formed on the bottom surface of the container member 44 of the waste ink tank 27 is located at a position in the receiving chamber 30 deeper than the locking stepped portion 40 formed at the attachment location 31 in the receiving chamber 30. In other words, at this time, the waste ink tank 27 departs from the attachment location 31 in the receiving chamber 30 in the attachment direction.

When the force (for example, the force of the user's hand) acting to move the waste ink tank 27 in the attachment direction is released from the state shown in FIG. 7, the brim portion 74 of the support member 72 goes forward with the urging force of the compressed coil springs 80 and thus the waste ink tank 27 is pressed to the front side (that is, in the detachment direction of the waste ink tank 27) by the brim portion 74. Then, the waste ink tank 27 slides forward over the middle step surface 38 of the attachment location 31 with the pressing force and the locking stepped portion 60 of the container member 44 is locked to the locking stepped portion 40 of the attachment location 31 as shown in FIG. 2. That is, the locking stepped portion 40 not lockable when the waste ink tank 27 moves in the attachment direction opposite to the detachment direction relative to the locking stepped portion 60 of the container member 44 serves as a locking unit regulating the movement in the detachment direction of the waste ink tank 27 when the waste ink tank 27 moves in the detachment direction.

Accordingly, the urging force of the coil springs 80 is applied to the waste ink tank 27 from the rear side through the brim portion 74 of the support member 72 and the locking stepped portion 40 of the attachment location 31 is locked to the locking stepped portion 60 of the bottom surface of the container member 44, whereby the waste ink tank 27 is positioned at the attachment location 31 in the receiving chamber 30 to be immovable in the front and rear directions as show in FIG. 2. Accordingly, the locking stepped portion 40 serving as the locking unit to the coil springs 80 as the urging unit serves as a holding unit holding the waste ink tank 27 at the attachment location 31. When the door 36 of the attachment and detachment port 34 is returned to the closing location, the pressing member 134 presses the front protruding portion 152 from the upside so as to allow the waste ink tank not to move in the up and down directions. In this way, the attachment operation of the waste ink tank 27 to the attachment location 31 is finished.

A method of recycling the container member 44 according to this embodiment will be described now. As described above, when the waste ink tank 27 is used in the printer 11 and collects a predetermined amount of ink, the waste ink tank 27 is replaced. At this time, when the container member 44 of the waste ink tank 27 can be reused, it is not necessary to form a new container member 44, which is advantageous in view of environment and economy.

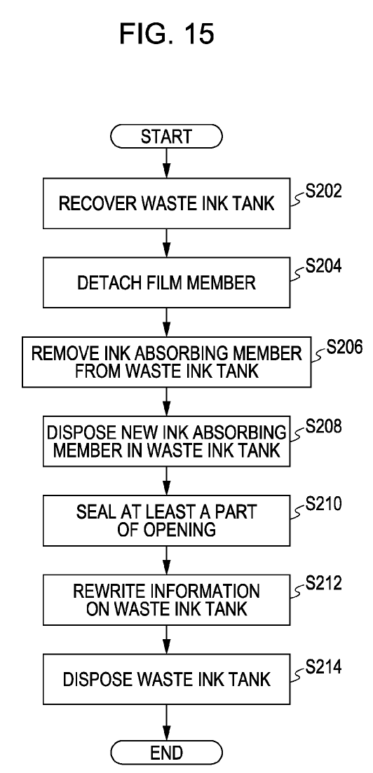

FIG. 15 is a flowchart illustrating the method of recycling the container member 44 according to this embodiment. The method of recycling the container member 44 will be described now with reference the flowchart.

First, the waste ink tank 27 is detached and recovered from the printer 11 (S202). The method of detaching the waste ink tank 27 is as described above. The waste ink tanks of plural printers 11 may be recovered together. The container members 44 of the recovered waste ink tanks 27 may be reused together in a recycle plant.

The film member 46 is detached from the used waste ink tank 27 (S204). The ink absorbing members 45a to 45d are removed from the opening 48 of the waste ink tank 27 (S206). The detachment of the film member 46 is performed by allowing a person recycling the waste ink tank 27 to grasp an end of the film member 46 and to peel off the film member from the container member 44. The film member 46 was welded to the container member 44. Accordingly, the welded portion of the film member 46 may be heated again to facilitate the peeling of the film member 46 from the container member 44 and then the film member 46 may be detached. In this way, it is possible to reduce the remainder of the film member at the position to which the film member 46 is welded.

Then, a non-used ink absorbing member is received in the container member 44 (S208). At this time, a non-used ink absorbing member having a material different from that of the used ink absorbing members 45a to 45d may be received in the container member 44. High-density fiber-structured polyurethane, foaming material, and absorbent high-molecular polymer are used for the non-used ink absorbing member. Specifically, water-absorbing paper, felt, cellulose, polyvinylalcohol (PVA), ethylene-vinyl acetate copolymer resin (EVA), acrylic acid grafted starch, acrylic salt grafted starch, vinylalcohol acrylic block copolymer, cross-linked polyacrylic acid, cross-linked polycarylic salt, denatured PVA, polystylene sulfonic acid, cellulose ester, carboxymethyl cellulose, and the like may be used.

The non-used ink absorbing member received in the container member 44 may have the same outer shape as the used ink absorbing members 45a to 45d. The non-used ink absorbing member may be a piece of non-used ink absorbing member as obtained by monolithically molding the ink absorbing members 45a to 45d.

The non-used ink absorbing member may have an outer shape different from that of the ink absorbing members 45a to 45d. For example, the outer shape of the ink absorbing member may be greater than the inner shape of the container member 44. As described below, the non-used ink absorbing member may have an outer shape different from that of the ink absorbing members 45a to 45d.

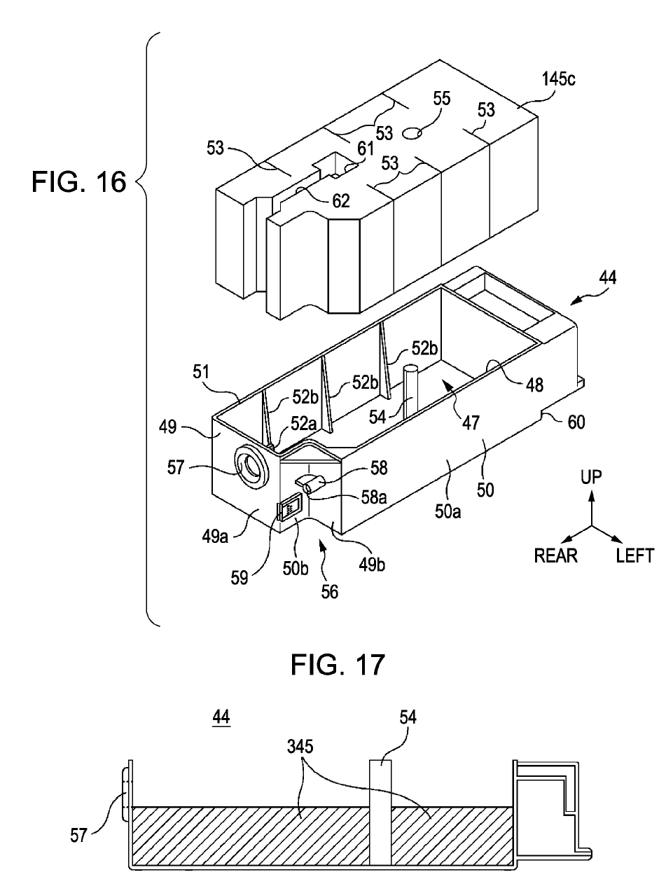

FIG. 16 is a diagram illustrating a state where a piece of ink absorbing member 145c is received in the container member 44. Four pieces of ink absorbing members 45a to 45d are used in the before-recycling waste ink tank 27, but a non-used ink absorbing member received newly may be a piece of ink absorbing member 145c. The non-used ink absorbing member 145c has a shape obtained by expanding the used ink absorbing member 45c in the height direction. Accordingly, similarly to the used ink absorbing member 45c, cut-in portions 53, a round hole 55, a rectangular through hole 61, and a cut-in groove 62 having a predetermined width are formed in the non-used ink absorbing member 145c.

In this case, by allowing a sharp cutting edge to move in the height direction and to cut the ink absorbing member, it is possible to form the outer shape of the ink absorbing member. The width of the cut-in groove 62 of the non-used ink absorbing member 145c to be newly received may be made to be greater.

The ink absorbing member may be received in a part of the container member 44 as follows.

FIG. 17 is a sectional view illustrating a state where an ink absorbing member 345 is received in only the bottom surface of the container member 44. In the drawing, a sectional view obtained by vertically cutting the container member 44 to pass through the center axis of the connection port 57 is shown. The circumferential shape of the ink absorbing member 345 is almost the same as the inner shape of the container member 44. A through hole passing a columnar post is formed in the ink absorbing member 345. The ink absorbing member 345 is disposed below the connection port 57.

When the capillary force of the ink absorbing member is not large, the waste ink hardly reaches the ink absorbing member located at a high position in spite of the stacking of the ink absorbing members in the height direction. Then, the ink absorbing member at a high position may be wasted. Accordingly, in this case, the ink absorbing member 345 may be disposed in only the bottom of the container member 44.

Accordingly, since the ink absorbing member is received in only a part of the container member 44, it is possible to save the ink absorbing member, thereby providing a recycled waste ink tank with low cost.

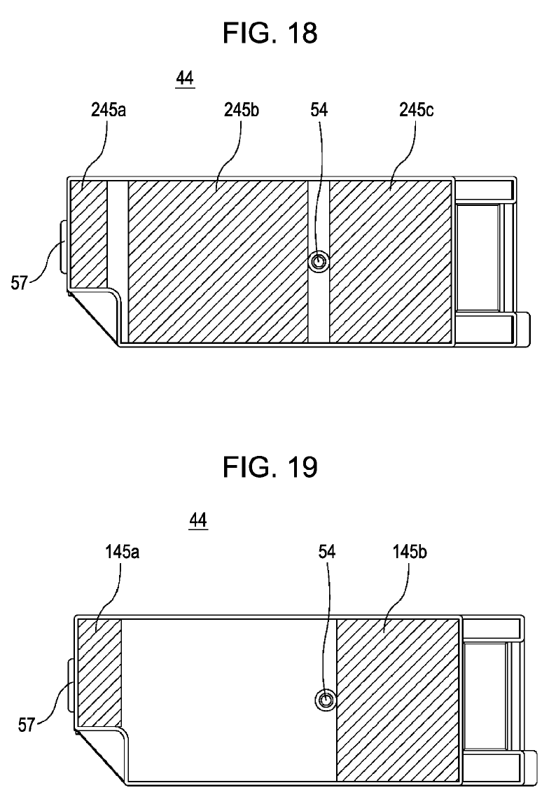

FIG. 18 is a top view illustrating a state where plural divided ink absorbing members are received in the container member 44. Here, the top view of the container member 44 before attaching the film member thereto is shown. Since an ink absorbing member having a simple rectangular shape can be more easily processed than an ink absorbing member having a complex shape, the shape can be formed with low cost. Accordingly, as shown in FIG. 11, plural ink absorbing members processed in a rectangular shape may be received in the container member 44.

FIG. 19 is a top view illustrating a state where an ink absorbing member 145a is received in the vicinity of the connection port 57 of the container member 44. Here, a top view of the container member 44 before attaching the film member thereto is shown. As shown in the drawing, when the ink absorbing member is divided in the front and rear directions of the container member 44 and is received in the container member 44, the ink absorbing member 145a may be disposed close to the connection port 57.

At this time, an ink absorbing member 145b may be disposed at a position most apart from the connection port 57. The ink absorbing member 145b is preferably processed in such a size that the location thereof can be fixed by the columnar post 54 and the inner wall of the container member 44.

The recycled waste ink tank is detached from the printer 11 while being inclined in the front and rear directions, similarly to the old waste ink tank. When the waste ink tank is inclined in the front and rear directions, the waste ink moves in the front and rear directions so as to lean to one side of the container member 44. However, since the ink absorbing members 145a and 145b are disposed at the position close to the connection port 57 and at the position most apart from the connection port 57, the leaning waste ink is absorbed by one of the ink absorbing members. Accordingly, it is possible to prevent the waste ink from leaking at the time of detaching the waste ink tank.

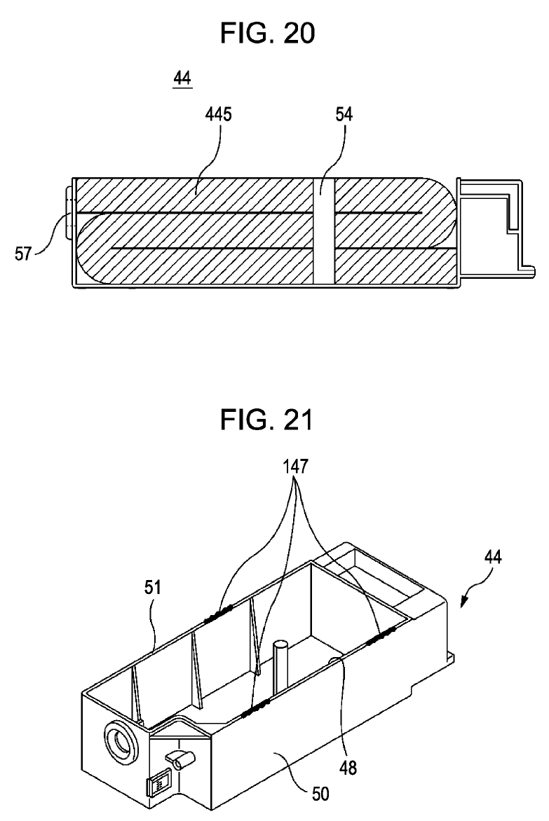

FIG. 20 is a sectional view illustrating a state where an ink absorbing member 445 is folded and received. In the drawing, a sectional view of the container member 44 taken vertically to pass through the center axis of the connection port 57 is shown. Here, the width of the ink absorbing member in the right and left directions is almost the same as the lateral width of the inside of the main rear side wall 49a. A hole passing the columnar post 54 is formed in the ink absorbing member 445 folded and received.

In this way, since the ink absorbing member 445 having almost the same size as the lateral width of the inside of the main rear side wall 49a is received, the ink absorbing member 445 is received in the container member 44 in a state where the ink absorbing member is nipped between the inner wall of the sub left side wall 50b and the inner wall of the right wall 51. In this case, since the ink absorbing member 445 exists below the tubular portion 76 inserted through the connection port 57, it is possible to effectively absorb the waste ink.

In this way, when the non-used ink absorbing member is received in the container member 44, at least a part of the opening 48 of the container member 44 is sealed with a sealing member (S210).

FIG. 21 is a diagram illustrating a state where a part 147 of the film member is attached to the periphery of the opening 48. When a part 147 of the film member remaining at the time of detaching the film member is attached to the periphery of the opening, a gap may be generated between the film member 46 and the container member 44 at the time of welding the film member 46 to the container member 44. Accordingly, it is preferable that the periphery of the opening 48 should be shaved to flatten the surface to which the film member 46 would be welded before sealing at least a part of the opening 48. Here, a part 147 of the film member remaining around the opening 48 is shaved. After the opening is flattened, the entire surface of the opening 48 can be sealed with a film member having the same outer shape as the film member 46 shown in FIG. 3.

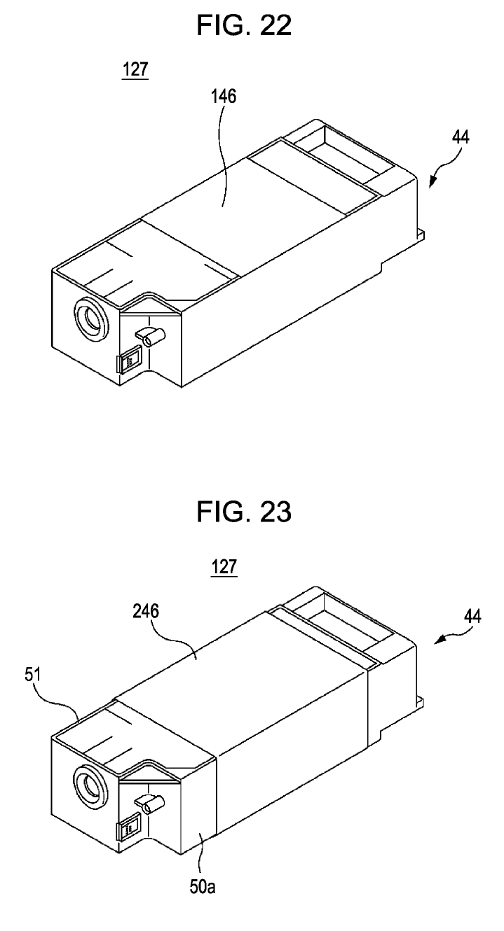

FIG. 22 is a diagram illustrating a state where the film member 146 is welded to a part of the opening 48. In the drawing, a recycled waste ink tank 127 to which the film member 146 is welded is shown. At the time of recycling the container member 44, as shown in the drawing, the film member 146 may be thermally welded and attached to only a part of the opening 48. In this case, it can be determined from the non-sealed portion whether the recycled waste ink tank 127 is a recycled product or a new product. By sealing only a part of the opening 48, it is not necessary to form the air hole 113 in the film member.

FIG. 23 is a diagram illustrating a state where the container member 44 is wound by the film member 246. In the drawing, a recycled waste ink tank 127 to which a film member 248 is attached is shown. At the time of sealing at least a part of the opening 48, as shown in the drawing, the film member 246 may be wound around the container member 44 so as to seal at least a part of the opening 48. The end of the film member 246 may be fixed with an adhesive. By attaching the film member 246 in this way, the film member 246 can be easily attached to the container member 44 even when a part of the old film member remains around the opening 48. It is possible to easily seal at least a part of the opening 48. A food wrapping film may be used as the film member 246 wound on the container member 44.

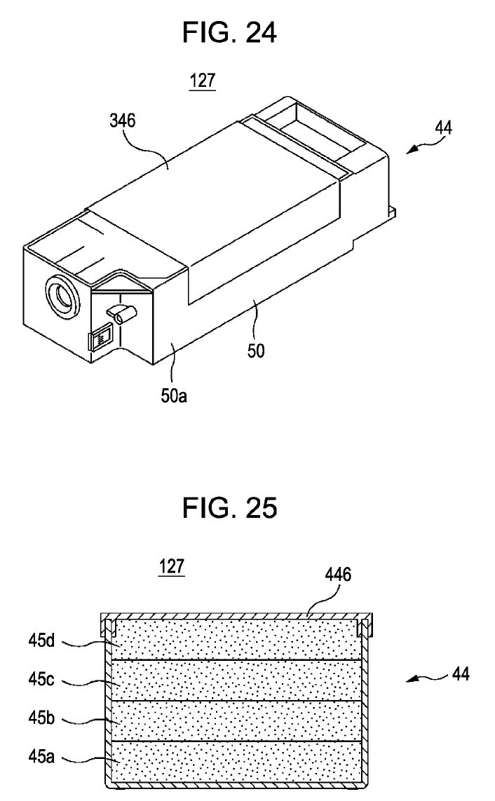

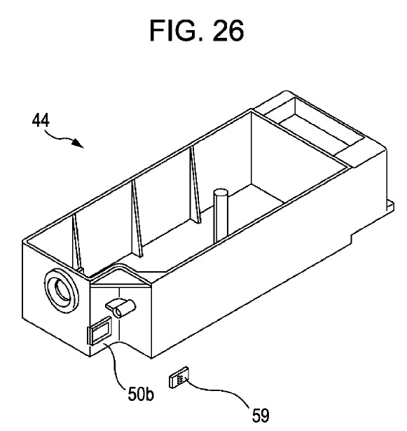

FIG. 24 is a diagram illustrating a state where a film member 346 is attached using a side wall of the container member 44. In the drawing, a recycled waste ink tank 127 to which the film member 346 is attached is shown. At the time of sealing at least a part of the opening 48, as shown in the drawing, end portions of the film member 346 may be bonded to the side walls 50 and 51 of the container member 44. By attaching the film member 346 in this way, the film member 346 can be easily attached to the container member 44 even when a part of the old film member remains around the opening 48.

FIG. 25 is a sectional view illustrating a state where a lid member 446 is attached to at least a part of the opening 48 of the container member 44. In the drawing, a section of a recycled waste ink tank 127 to which the lid member 446 is attached is shown. As shown in the drawing, at the time of sealing at least a part of the opening 48, the lid member 446 fitted to the top portions of the side walls 50 and 51 of the container member 44 may be attached. By providing the lid member 446, it is possible to easily extract the ink absorbing members from the opening 48 at the time of recycling the container member 44.

Although at least a part of the opening 48 is sealed in step S210, the container member 44 receiving the ink absorbing members without sealing the opening 48 may be used as the recycled waste ink tank 127. In this case, the processes of steps S112 to S114 described below may be performed without performing the process of step S210 in FIG. 15. The sealing of at least a part of the opening 48 includes sealing the entire opening 48 as shown in FIG. 3.

When the non-used ink absorbing members having the same shape as the ink absorbing members 45a to 45d shown in FIG. 3 are received and a part of the opening 48 is sealed, the sealed part of the opening 48 is preferably a portion above the through hole 61. In this case, since the discharged waste ink is suppressed from immediate vaporization, the ink absorbing members do not clog in the vicinity of the through hole 61 and thus the waste ink can easily diffuse into the ink absorbing members as a whole. In addition, since the waste ink is vaporized from the non-covered portion of the opening 48, a more amount of waste ink can be collected. Accordingly, it is preferable that the non-covered portion of the opening 48 is apart from the discharge portion. However, when ink can diffuse as a whole in spite of the vaporization thereof, the sealed part is not particularly limited.

In this way, when the opening 48 of the container member 44 is sealed, information on the waste ink tank is then rewritten to the circuit board of the connection terminal 59 (S212).

The circuit board is formed in the connection terminal 59. The circuit board includes an EPROM (Erasable Programmable ROM) which information can be erased from and written to and stores a variety of information on the waste ink tank 127. For example, the number of reusable times of the container member 44, the amount of collectable ink of the waste ink tank, and the manufacturing date of the waste ink tank are stored in the circuit board.

The amount of collectable ink is predetermined for the waste ink 127. Accordingly, whenever the waste ink is discharged to the waste ink tank 127, the printer 11 counts the amount of discharged ink, subtracts the amount of discharge ink from the amount of collectable ink stored in the circuit board, and rewrites the result. Therefore, by allowing the circuit board to store the amount of collectable ink, the printer 11 can monitor the amount of collectable ink of the waste ink tank 127 so that the amount of discharged ink should not exceed the amount of collectable ink.

At the time of recycling the waste ink tank 127, the stored amount of collectable ink can be rewritten to the circuit board so as to be the amount of collectable ink of a non-used waste ink tank. For example, when the amount of collectable ink of the waste ink tank is reduced to 0 g by use, the amount of collectable ink is rewritten to the circuit board as 60 g which is the amount of collectable ink of a non-used waste ink tank, at the time of recycling the waste ink tank 27.

Since the recycled waste ink tank 127 is a recycled product, a smaller amount of collectable ink may be rewritten. For example, 60 g is written to the circuit board as the amount of collectable ink of a new waste ink tank 27, but 50 g may be rewritten as the amount of collectable ink to the circuit board of the recycled waste ink tank 127.

The number of reusable times of the container member 44 may be stored in the circuit board and the number of reusable times of the container member 44 may be reduced and stored in the circuit board when ever the waste ink tank 127 is recycled. Accordingly, it is possible to know the lifetime of the container member 44. For the following reason, it is necessary to know the lifetime of the container member 44.

As described above, at the time of recycling the container member 44, the welding surface of the film member may be shaved. Then, the amount of shaved portion increases with the increase of the number of reused times and thus the height of the container member 44 may be reduced. In this case, there is a problem in that the ink absorbing member having an expected size may not be received or only an amount of waste ink smaller than an expected amount of collectable ink can be collected. Accordingly, the number of reused times of the container member 44 is stored in the circuit board to know the lifetime of the container member 44.

FIG. 24 is a diagram illustrating a state where the connection terminal 59 is demounted from the container member 44. In this way, at the time of updating the details stored in the circuit board 59a, the connection terminal 59 may be demounted from the container member 44. The connection terminal 59 may be demounted from the container member 44 and then a new connection terminal may be mounted thereon.

As described above, when the waste ink tank 127 is recycled reusing the container member 44, the recycled waste ink tank 127 is attached to the printer 11 (S214). Since the recycled waste ink tank 127 is manufactured using the container member 44, the outer shape thereof is almost the same as the old waste ink tank 27. Accordingly, the recycled waste ink tank can be attached to the printer 11, similarly to the old waste ink tank 27.

The processes of steps S204 to S212 may be performed by a person other than the user.

Other modifications of the second embodiment of the invention will be described now.

Although an ink jet printer is embodied as a fluid ejecting apparatus having the recycled waste liquid collector (waste ink tank) reusing the container member in the above-mentioned embodiment, the invention may be applied to a fluid ejecting apparatus spraying or ejecting a liquid (including a liquid-like material in which particles of a functional material are dispersed and a colloidal material such as gel, in addition to the liquid) other than the ink or a fluid (such as solid that can be made to flow and ejected as a fluid) other than the liquid. For example, the fluid ejecting apparatus may be a liquid-like material ejecting apparatus ejecting a liquid-like material in which materials such as an electrode material or a coloring material used for manufacturing a liquid crystal display, an electroluminescence (EL) display, and a surface-emission display are dispersed or melted, a liquid ejecting apparatus ejecting bio organics used for manufacturing a bio chip, or a liquid ejecting apparatus used as a precise pipette to eject a liquid as a sample. In addition, the fluid ejecting apparatus may be a liquid ejecting apparatus ejecting lubricant to a precise machine such as a clock or a camera by the use of a pin point, a liquid ejecting apparatus ejecting a transparent resin liquid such as a UV-curable resin onto a substrate to form a micro semi-circular lens (optical lens) used in an optical communication device, a liquid ejecting apparatus ejecting etchant such as acid or alkali to etch a substrate and the like, a colloidal material ejecting apparatus ejecting such as gel, or a powder-ejecting recording apparatus ejecting a solid such as toner powder. The invention can be applied to one of the above-mentioned ejecting apparatuses.

In this embodiment, the ink includes aqueous ink and oily ink.

The above-mentioned embodiment is intended for easy understanding of the invention, but not for definitely analyzing the invention. The invention can be modified and improved without departing from the gist thereof and equivalents thereof can be included in the invention. The embodiments are also included in the invention.

Hereinafter, a third embodiment of the invention will be described.

FIG. 1 is a perspective view illustrating an ink jet printer according to the first embodiment of the invention. FIG. 2 is a partially-omitted sectional view illustrating a housing in the printer. FIG. 3 is an exploded perspective view illustrating a waste ink tank. FIG. 4 is an exploded perspective view illustrating a tube supporting mechanism. FIG. 5A is a partially-exploded front view illustrating the tube supporting mechanism and FIG. 5B is a partially-exploded front view illustrating the tube supporting mechanism in a state where a support member retreats.

Hereinafter, a waste liquid collecting system in an ink jet printer which is a kind of liquid ejecting apparatus will be described with reference to the drawings. “Front and rear directions”, “up and down directions”, and “right and left directions” in the following description means “front and rear directions”, “up and down directions”, and “right and left directions” indicated by arrows in FIGS. 1 to 4.

As shown in FIG. 1, an ink jet printer (hereinafter, referred to as “printer”) 11 as a liquid ejecting apparatus according to this embodiment includes a frame 12 having a rectangular shape in a plan view.

A transport roller 13 extends in the right and left directions in the frame 12. A printing sheet P is fed from the rear side to the front side by allowing the transport roller 13 to rotate by the use of a sheet feeding motor 14. In addition, a guide shaft 15 extending in parallel to a longitudinal direction (the right and left directions) of the transport roller 13 is disposed above the transport roller 13 in the frame 12.

A carriage 16 is supported by the guide shaft 15 so as to reciprocate along an axial line direction (the right and left directions) of the guide shaft 15. A driving pulley 17 and a driven pulley 18 are rotatably supported at positions corresponding to both ends of the guide shaft 15 in the rear surface of the frame 12, respectively. A carriage motor 19 serving as a driving source for allowing the carriage 16 to reciprocate is connected to the driving pulley 17. A timing belt 20 fixing and supporting the carriage 16 is suspended between the pair of pulleys 17 and 18. Accordingly, the carriage 16 moves in the right and left directions through the timing belt 20 by the carriage motor 19 while being guided by the guide shaft 15.

As shown in FIG. 1, a print head as a liquid ejecting head 21 is disposed on the lower surface of the carriage 16. On the other hand, plural ink cartridges 23 for supplying ink as a liquid to the print head 21 are detachably mounted on the carriage 16. The ink cartridges 23 individually correspond to plural nozzle opening lines (not shown) formed in a nozzle formation surface 21a (see FIG. 2) which is the lower surface of the print head 21 and individually supply ink to the corresponding nozzle opening lines through ink passages (not shown) formed in the print head 21.

A home position HP serving as a maintenance position where the carriage 16 is located at the time of turning off the printer 11 or maintaining the print head 21 is disposed in one end (the right end in FIG. 1) in the frame 12, that is, in a non-printing area which the printing sheet P does not reach. In addition, a maintenance unit 24 performing various maintenance operations is disposed below the home position HP so as to satisfactorily eject ink to the printing sheet P from the print head 21.

The maintenance unit 24 includes a cap 25 having a substantially rectangular shape corresponding to the lower surface (the nozzle formation surface) of the print head 21 and an elevation mechanism (not shown) moving up and down the cap 25. In addition, when the cap 25 moves up by the driving of the elevation mechanism (not shown) with the carriage 16 located at the home position HP, the cap 25 comes in contact with the nozzle formation surface 21a which is the lower surface of the print head 21 so as to surround the nozzle opening lines.

As shown in FIGS. 1 and 2, a housing 26 having a rectangular parallelepiped shape in the front and rear directions is formed at one end (the right end in FIG. 1) in the frame 12 and below the home position HP. A receiving chamber 30 receiving a waste liquid collecting system 29 including a waste ink tank 27 as a waste liquid collector and a tube supporting mechanism 28 as a liquid passage forming unit is formed in the housing 26. An attachment location 31 of the waste ink tank 27 is set in a lower portion of the receiving chamber 30. As shown in FIG. 2, the height (which is a distance between a bottom wall 32 and a top wall 33) of the receiving chamber 30 is set sufficiently higher than the height of the waste ink tank 27 so that the waste ink tank 27 can be tilted inside the receiving chamber 30.

When the cap 25 moves up from the state shown in FIG. 2 by the driving of the elevation mechanism (not shown) and comes in contact with the nozzle formation surface 21a of the print head 21, a suction pump 42 is driven. Then, the thickened ink in the print head 21 is forcibly sucked and discharged (ejected) as waste ink into the cap 25 through nozzle openings (not shown) by a negative pressure generated in the cap 25. When an idle suction state of sucking the atmospheric air is reached by exposing the inside of the cap 25 to the atmospheric air in a state where the suction pump 42 is being driven, the waste ink is discharged from the cap 25 to the waste ink tank 27.

A rectangular attachment and detachment port 34 through which the waste ink tank 27 passes upon attaching or detaching the waste ink tank 27 to or from the attachment location 31 in the receiving chamber 30 is formed on the front surface of the housing 26. A door 36 of which the upper end portion is rotatably supported on a pair of right and left shafts 35 formed at both ends of the upper edge of the attachment and detachment port 34 is disposed in the attachment and detachment port 34. By grasping a knob 36a formed on the front surface of the door 36 and opening or closing the door 36 about the shafts 35, the door 36 moves between a closing location indicated by a solid line and an opening location indicated a two-dot chain line in FIG. 2.

A pressing member 134 pressing a front protruding portion 152 of the waste ink tank 27 from the upside is formed monolithically with the door 36. Accordingly, it is possible to prevent the front side of the waste ink tank 27 from floating, by closing the door 36.

As shown in FIG. 2, in the receiving chamber 30 of the housing 26, a front step surface 37, a middle step surface 38, and a rear step surface 39 are formed in a step shape on the upper surface of the bottom wall 32 from the front side to the rear side in the front and rear directions. The front step surface 37 has the same height as the lower edge of the attachment and detachment port 34. A locking step 40 as a locking portion making the middle step surface 38 lower than the front step surface 37 is formed between the rear end of the front step surface 37 and the front end of the middle step surface 38 so as to extend in the right and left directions.

The middle step surface 38 has a length in the front and rear directions slightly smaller than the length of the waste ink tank 27 in the front and rear directions. The almost entire area of the middle step surface 38 and the rear half area of the front step surface 37 form the attachment location 31 of the waste ink tank 27. The rear step surface 39 is slightly lower than the middle step surface 38 with a stepped portion 41 interposed therebetween. The tube supporting mechanism 28 supporting a flexible tube 43, which discharges the ink forcibly sucked as the waste ink (waste liquid) from the cap 25 to the waste ink tank 27 by the driving of the suction pump 42, is disposed on the rear step surface 39.

The waste ink tank 27 will be described now. As shown in FIG. 3, the waste ink tank 27 includes a container member 44 having a bottomed box shape of which the top is opened, plural ink absorbing members (waste liquid absorbing members) 45a to 45d having an outer shape corresponding to the opening shape of the container member 44, and a film member 46 as a gas-liquid non-transmitting member having an outer shape corresponding to the opening shape of the container member 44. The inside of the container member 44 serves as a receiving space 47 and the ink absorbing members 45a to 45d are stacked and received in the receiving space 47. The opening 48 of the container member 44 is sealed by bonding (welding in this embodiment) the film member 46 to the container member 44 to cover the opening 48 of the container member 44 having received the ink absorbing members 45a to 45d are received. An air hole 113 is formed at a position of the film member 46 bonded to the container member 44. As described above, the front protruding portion 152 is formed in the container member 44 so as to extend in the right and left directions.

Ribs 52 having a thin plate shape are formed in the up and down directions in the inner surface of a rear side wall 49 of the container member 44. Similarly, ribs 52b having a thin plate shape are formed in the up and down directions on right and left side walls 50 and 51. Only one rib 52a on the rear side wall 49 and three ribs 52b on the right side wall 51 are shown in FIG. 3. In addition, cut-in portions 53 are formed in the outer edges of the ink absorbing members 45a to 45d so as to correspond to the positions of the ribs 52a and 52b.

A columnar post 54 is formed upright at a position slightly closer to the front than the center of the bottom surface of the container member 44. Round holes 55 are formed upright at a position slightly closer to the front than the center of the ink absorbing members 45 so as to correspond to the post 54. The corresponding ribs 52a and 52b are inserted into the cut-in portions 53 and the post 54 is inserted into the holes 55, whereby the ink absorbing members 45a to 45d are stacked and received in the receiving space 47 of the container member 44.

As shown in FIG. 3, a concave portion 56 is formed in the rear-left corner of the container member 44. As a result, the rear side wall 49 is divided into a main rear side wall 49a located on the relative rear side and a sub rear side wall 49b located on the relative front side and the left side wall 50 is divided into a main left side wall 50a located on the relative left side and a sub left side wall 50b located on the relative right side.

A round connection port 57 is formed in the main rear side wall 49a. The connection port 57 has a diameter which gradually decreases from the opening edge to a deep side and has a function of guiding a member to a deep center of the connection port 57 when the member inserted into the connection port 57 from the outside comes in contact with the inner circumferential surface of the connection port 57 in the front and rear directions. Specifically, since the inner circumferential surface of the connection port 57 in the waste ink tank 27 is a tapered surface of which the diameter decreases to the deep side of the connection port 57, a tubular body 73 of a support member 72 to be described later is slidably guided to the center of the connection port 57 as it is inserted into the connection port 57.

The shape of the connection port 57 is not limited to the round shape. The connection port 57 may have, for example, a triangular shape, a polygonal shape, or an elliptical shape. In the drawing, the connection port 57 protrudes more than the rear side wall 49, but may be formed not to protrude.

A cylinder portion 58 protrudes to the rear side from the sub rear side wall 49b and the hole of the cylinder portion 58 forms a positioning hole 58a. As described later, a positioning pin 85 protruding from a brim portion 74 of the support member 72 is inserted into the positioning hole 58a of the cylinder portion 58. Accordingly, the positioning pin 85 and the positioning hole 58a serve as a holding unit holding the waste ink tank 27 to regulate the movement thereof in the up and down directions and the right and left directions at the attachment location 31.

When the shape of the positioning pin 85 is not cylindrical, the shape of the positioning hole 58a may not be cylindrical. For example, when the outer shape of the positioning pin 85 is rectangular, the positioning hole 58a may be a hole having a concave portion into which the pin is inserted. When the positioning pin 85 is a simple plate-like member, the positioning hole 58a may be a plate-like member capable of coming in contact with the pin to position the pin.

A connection terminal 59 having a circuit board storing various information of the waste ink tank 27 to be described later is mounted on the outer surface of the sub left side wall 50b. A locking stepped portion 60 engaging with the locking stepped portion 40 formed on the bottom wall 32 of the housing 26 in the front and rear directions is formed at a position slightly closer to the rear end than the front end of the bottom surface of the container member 44 so as to extend in the right and left directions.

As shown in FIG. 3, among the ink absorbing members 45a to 45d, the lowermost first ink absorbing member 45a and the uppermost fourth ink absorbing member 45d have the same thickness and the same shape and the second ink absorbing member 45b stacked as the second layer from the bottom and the third ink absorbing member 45c stacked as the third layer from the bottom have the same thickness. A through-hole 61 having a square shape is formed in a position slightly closer to the rear side than the center in each of the second ink absorbing member 45b and the third ink absorbing member 45c. A cut-in groove 62 having a predetermined width is formed in the third ink absorbing member 45c in the front and rear directions from the rear edge to the through hole 61.

As shown in FIG. 3, the first ink absorbing member 45a stops the through hole 61 from the downside and the fourth ink absorbing member 45d stops the through hole 61 from the upside. When a front tubular portion 76 is inserted into the cut-in groove 62, the waste ink discharged from the front tubular portion 76 drops on the top surface of the first ink absorbing member 45a and is absorbed therein. As the amount of waste ink absorbed increases, the waste ink slowly diffuses from the first ink absorbing member 45a to the upper ink absorbing members.

Here, when the amount of waste ink is great, the waste ink cannot diffuse into the first ink absorbing member 45a. Accordingly, the through hole 61 temporarily stores the waste ink. That is, the discharged waste ink is stored until the waste ink is absorbed by the ink absorbing members (the waste ink diffuses into the ink absorbing members). Therefore, it is preferable that the through hole 61 has such a size to contain the discharged waste ink. When the container member 44 is detached and the posture of the container member 44 is upside-down in the state where the through hole 61 stores the waste ink, the fourth ink absorbing member 45d absorbs the waste ink stored in the through hole 61 to prevent the ink from leaking to the outside of the container member 44. The fourth ink absorbing member 45d suppresses the discharged waste ink from vaporization. When the waste ink is vaporized, the ink absorbing member clogs due to the thickened ink and thus the waste ink discharged later hardly diffuses therein. The fourth ink absorbing member 45d stops the through hole 61 to suppress the waste ink from vaporization from the top surface of the first ink absorbing member 45a onto which the discharged waste ink drops and is located above the ink absorbing members 45a, 45b, and 45c to suppress the waste ink from vaporization from the three ink absorbing members.

The waste ink tank 27 is constructed as described above. The ink absorbing members may be received in the container member 44 in a manner different from the above description. Similarly to the recycled waste ink tank 127 to be described later, the sealing member may seal at least a part of the opening of the container member 44 in a manner different from the above description.

The tube supporting mechanism 28 will be described now. As shown in FIG. 4 and FIGS. 5A and 5B, the tube supporting mechanism 28 includes a base body 63 having a substantial ⊃ shape in a plan view in which a front end distance between both side walls having a rectangular shape is constant and in which the front ends of both side walls are connected to each other with a rectangular front wall. A horizontal plate 64 having a rectangular plate shape extends forward from the lower front end of the base body 63 and right and left screw holes 65 are formed in the horizontal plate 64. The base body 63 is fixed to the rear step surface 39 of the bottom wall 32 of the housing 26 by screwing setscrews 66 to the screw holes 65 of the horizontal plate 64, respectively.

As shown in FIG. 4, plural through holes 67, 68, and 69 (three through holes in this embodiment) are formed in the front wall of the base body 63 so as to extend in the up and down directions. Among the through holes 67 to 69, the central through hole 68 has such a height to be coaxial with the connection port 57 of the waste ink tank 27 attached to the attachment location 31 of the receiving chamber 30, when the base body 63 is fixed onto the rear step surface 39 of the bottom wall 32 of the housing 26. An inward flange 70 (see FIGS. 5A and 5B) is formed at an intermediate position in an axial direction of the inner circumferential surface of each of the upper through hole 67 and the lower through hole 69. In addition, a substantially U-shaped tube fixing portion 71 through which the flexible tube 43 is inserted to be supported is formed in the substantially central portion of the upper end of the front wall of the base body 63.

As shown in FIG. 4 and FIGS. 5A and 5B, a support member 72 linearly supporting the flexible tube 43 is assembled with the front surface of the base body 63. The support member 72 is a resin-molded product having rigidity, including a tubular body 73 as a main member which can be inserted into or detached from the connection port 57 of the waste ink tank 27, and having a predetermined length in the front and rear directions. A brim portion 74 having a rectangular plate shape is monolithically formed at a position closer to the rear side (base end side) than the center in an axial direction of the tubular body 73. In the support member 72, a base-end tubular portion (second support member) 75 protruding more rearward than the brim portion 74 of the tubular body 73 has an outer diameter smaller than the diameter of the intermediate through hole 68 of the base body 63 and an inner diameter into which the flexible tube 43 can be inserted.

On the other hand, in the support member 72, a predetermined length portion of the tubular body 73 serving as a second support portion in front of (on the front side) the brim portion 74 has an outer diameter slightly smaller than the width of the cut-in groove 62 of the third ink absorbing member 45c received in the waste ink tank 27 and a length almost equal to the distance from the rear edge of the third ink absorbing member 45c to the center of the through hole 61. In the predetermined length portion of the tubular body 73 in front of the brim portion 74, a relatively-long tubular portion from the front tubular portion 76 to the rear brim portion 74, except for the relatively-short front tubular portion 76 having a cylinder shape into which the front end as a downstream end of the flexible tube 43 is inserted, is formed as a non-tubular portion 77 in which about a half of the circumferential wall is cut out. In the inner surface of the non-tubular portion 77, insertion claws (fixing portions) 78 forming pairs protrude from plural positions (three positions in this embodiment) in the axial direction of the tubular body 73 so that the distance from the opposite insertion claw 78 is slightly smaller than the outer diameter of the flexible tube 43.

In the support member 72, when the base-side tubular portion 75 of the tubular body 73 is loosely inserted into the central through hole 68 of the base body 63, the front-side predetermined length portion including the front end (downstream end) of the flexible tube 43 inserted from the base-side opening of the base-side tubular portion 75 is supported by the front tubular portion 76 and the non-tubular portion 77. That is, the front tubular portion 76 in the tubular body 73 supports the front end of the flexible tube 43 in the inserted state since the inner diameter of the front tubular portion 76 is equal to the outer diameter of the flexible tube 43. In addition, the non-tubular portion 77 fixes the flexible tube 43 by inserting the flexible tube 43 from the side so that the fixing claws 78 fix the plural locations (three locations in this embodiment) of the portion extending from the front end to the base end of the flexible tube 43. Accordingly, the front-side predetermined length portion in the flexible tube 43 is supported by the tubular body 73 of the support member 72 so as to extend in a direction in which the front end of the flexible tube 43 is oriented.

A positioning pin 85 which can be inserted into or detached from the positioning hole 58a of the cylinder portion 58 of the waste ink tank 27 protrudes forward from the left edge of the front surface of the brim portion 74 of the support member 72. Likewise, a vertical plate portion 86 having a rectangular plate shape protrudes from a position below the positioning pin 85 in the left edge of the front surface of the brim portion 74. A connection terminal 87 corresponding to the connection terminal 59 formed on the sub left side wall 50b of the waste ink tank 27 is mounted on one surface (right surface) of the vertical plate portion 86. The connection terminal 87 is connected to a control unit (not shown) of the printer 11 through a harness (not shown).

On the other hand, a pair of upper and lower cylinders 79 that can be respectively inserted into the upper through hole 67 and the lower through hole 69 of the base body 63 protrudes in parallel backward from two upper and lower positions of the base-side tubular portion 75 in the rear surface of the brim portion 74 of the support member 72. In addition, the upper and lower cylinders 79 are respectively inserted into the upper through hole 67 and the lower through hole 69 of the base body 63 in a state where the cylinders 79 are put into coil springs 80 serving as an urging unit against the circumferential surfaces. In this case, the front ends of the coil springs 80 come in contact with the rear surface of the brim portion 74 of the support member 72 and the rear ends thereof come in contact with the flanges 70 formed at the middle positions of the inner circumferential surfaces of the upper through hole 67 and the lower through hole 69, respectively. Screw holes (not shown) are formed on the front end surfaces of the cylinders 79, respectively.

As shown in FIG. 4 and FIGS. 5A and 5B, an assembly plate 81 assembling the support member 72 into the base body 63 is disposed on the rear surface of the base body 63. The assembly plate 81 has a rectangular plate shape coming in contact with the rear surface of the front wall when the assembly plate 81 is disposed between both side walls of the base body 63 having the substantial ⊃ shape in a plan view. A through hole 82 corresponding to the central through hole 68 of the base body 63 is formed in the substantial center of the assembly plate 81. Screw insertion holes 83 are formed at two positions, which correspond to the upper through hole 67 and the lower through hole 69 of the base body 63, above and below the through hole 82 in the assembly plate 81. In addition, the assembly plate 81 is screwed to the cylinders 79 of the support member 72 of which the front ends protrude backward from the upper through hole 67 and the lower through hole 69 of the base body 63 with setscrews 84 inserted into the screw insertion holes 83.

A method of detaching the waste ink tank 27 from the printer 11 will be described now with reference to FIG. 2 again.

As shown in FIG. 2, when the waste ink tank 27 attached to the attachment location 31 in the receiving chamber 30 is detached from the printer 11, the door 36 of the attachment and detachment port 34 is opened and a user of the printer 11 puts his hand into the attachment and detachment port 34 and grasps the front end portion of the waste ink tank 27. Then, the user lifts up the front end portion of the waste ink tank 27 to incline the posture of the waste ink tank 27 and thus unlocks the locking stepped portion 40 from the locking stepped portion 60. In this state, since the urging force of the coil springs 80 acts on the waste ink tank 27 through the brim portion 74 of the support member 72 in the detachment direction (to the front side), the urging force assists the movement in the detachment direction and thus the waste ink tank 27 is easily detached through the attachment and detachment port 34.

A method of attaching the waste ink tank 27 to the printer 11 will be described now. Here, a new waste ink tank 27 may be a waste ink tank 27 of which the container member 44 is recycled as described later.

FIG. 6 is a partially-omitted sectional view (first) illustrating the inside of the receiving chamber at the time of detaching the waste ink tank 27. FIG. 7 is a partially-omitted sectional view (second) illustrating the inside of the receiving chamber at the time of detaching the waste ink tank.

When the waste ink tank 27 is attached to the attachment location 31 of the receiving chamber 30, first, the door 36 on the front surface of the housing 26 is opened. The waste ink tank 27 is inserted into the opened attachment and detachment port 34 from the rear end thereof where the connection port 57 is formed and the waste ink tank 27 is made to move to the rear side which is the attachment direction to the attachment location 31. Then, as shown in FIG. 6, in the front step where the entire waste ink tank 27 is inserted into the receiving chamber 30, the front tubular shape 76 of the tubular body 73 of the support member 72 in the tube supporting mechanism 28 is inserted into the connection port 57 of the main rear side wall 49a.

In the tube supporting mechanism 28 according to this embodiment, the front end of the support member 72 is pivotable about the base end thereof. Accordingly, when the front tubular portion 76 of the tubular body 73 is inserted into the connection port 57 of the waste ink tank 27 moving with its posture inclined, the support member 72 of the tube supporting mechanism 28 allows its front end to pivot to correspond to the inclination. Therefore, the front tubular portion 76 of the tubular body 73 in the support member 72 is inserted to the deep position of the connection port 57 of the waste ink tank 27 without interference.

When the waste ink tank 27 is made to further move toward the deep position of the receiving chamber 30 from the state shown in FIG. 6, the rear side wall 49 of the waste ink tank 27 comes in contact with the brim portion 74 of the support member 72 and the front tubular portion 76 of the tubular body 73 of the support member 72 reaches the position of the through hole 61 formed in the third ink absorbing member 45c. In this case, when the rear side wall 49 of the waste ink tank 27 comes in contact with the brim portion 74 of the support member 72, the positioning pin 85 protruding from the brim portion 74 of the support member 72 is inserted into the positioning hole 58a of the cylinder portion 58 disposed in the sub rear side wall 49b of the waste ink tank 27, whereby the waste ink tank 27 is positioned in the up and down directions and the right and left directions relative to the attachment location 31.

When the waste ink tank 27 is further pushed from this state so as to press the brim portion 74 of the support member 72, the support member 72 further retreats while further compressing the coil springs 80. When the brim portion 74 of the support member 72 retreats to the position closes to the front wall of the base body 63, as shown in FIG. 7, the waste ink tank 27 is changed to a horizontal posture and the bottom surface of the container member 44 in the waste ink tank 27 is brought into surface contact with the middle step surface 38 which is a part of the attachment location 31 in the receiving chamber 30. At this time, the locking stepped portion 60 formed on the bottom surface of the container member 44 of the waste ink tank 27 is located at a position in the receiving chamber 30 deeper than the locking stepped portion 40 formed at the attachment location 31 in the receiving chamber 30. In other words, at this time, the waste ink tank 27 departs from the attachment location 31 in the receiving chamber 30 in the attachment direction.

When the force (for example, the force of the user's hand) acting to move the waste ink tank 27 in the attachment direction is released from the state shown in FIG. 7, the brim portion 74 of the support member 72 goes forward with the urging force of the compressed coil springs 80 and thus the waste ink tank 27 is pressed to the front side (that is, in the detachment direction of the waste ink tank 27) by the brim portion 74. Then, the waste ink tank 27 slides forward over the middle step surface 38 of the attachment location 31 with the pressing force and the locking stepped portion 60 of the container member 44 is locked to the locking stepped portion 40 of the attachment location 31 as shown in FIG. 2. That is, the locking stepped portion 40 not lockable when the waste ink tank 27 moves in the attachment direction opposite to the detachment direction relative to the locking stepped portion 60 of the container member 44 serves as a locking unit regulating the movement in the detachment direction of the waste ink tank 27 when the waste ink tank 27 slides and moves in the detachment direction.

Accordingly, the urging force of the coil springs 80 is applied to the waste ink tank 27 from the rear side through the brim portion 74 of the support member 72 and the locking stepped portion 40 of the attachment location 31 is locked to the locking stepped portion 60 of the bottom surface of the container member 44, whereby the waste ink tank 27 is positioned at the attachment location 31 in the receiving chamber 30 to be immovable in the front and rear directions as shown in FIG. 2. Accordingly, the locking stepped portion 40 serving as the locking unit to the coil springs 80 as the urging unit serves as a holding unit holding the waste ink tank 27 at the attachment location 31. When the door 36 of the attachment and detachment port 34 is returned to the closing location, the pressing member 134 presses the front protruding portion 152 from the upside so as to allow the waste ink tank not to move in the up and down directions. In this way, the attachment operation of the waste ink tank 27 to the attachment location 31 is finished.

A method of recycling the container member 44 according to this embodiment will be described now. As described above, when the waste ink tank 27 is used in the printer 11 and collects a predetermined amount of ink, the waste ink tank 27 is replaced. At this time, when the container member 44 of the waste ink tank 27 can be reused, it is not necessary to form a new container member 44, which is advantageous in view of environment and economy.

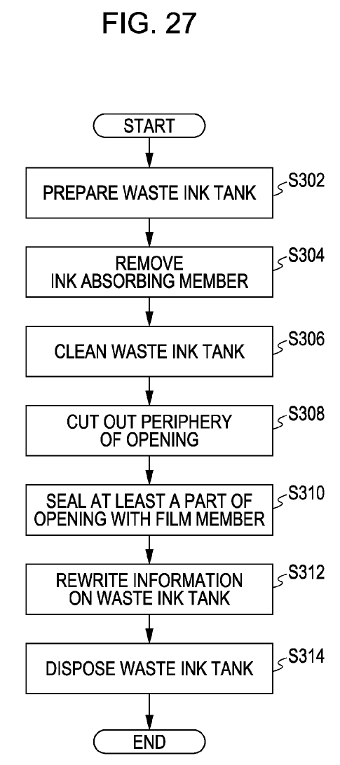

FIG. 27 is a flowchart illustrating the method of recycling the container member 44 according to this embodiment. The method of recycling the container member 44 will be described now with reference the flowchart.

First, the waste ink tank 27 is detached from the printer 11 and the old waste ink tank 27 is recovered (S302). The method of detaching the waste ink tank 27 is as described above. The container member 44 of the detached waste ink tank 27 is recycled as follows. The waste ink tanks 27 detached from plural printers 11 may be recovered together. The recovered waste ink tanks 27 may be recycled together in a recycle plant as follows.

The film member 46 is detached from the old waste ink tank 27 and the ink absorbing members 45a to 45d are removed from the opening 48 (S304). The detachment of the film member 46 is performed by allowing a person recycling the waste ink tank 27 to grasp an end of the film member 46 and to peel off the film member from the container member 44. The film member 46 was welded to the container member 44. Accordingly, the welded portion of the film member 46 may be heated again to facilitate the peeling of the film member 46 from the container member 44 and then the film member 46 may be detached. In this way, it is possible to detach the film member while minimizing the remainder of the film member in the top portion of the wall to which the film member 46 is attached.

Then, the inside of the waste ink tank 27 from which the ink absorbing members 45a to 45d are removed is cleaned (S306). Dirt may be attached to the inside of the used waste ink tank 27 due to the contained waste ink. The solidified waste ink may serve as an adhesive and thus may bond a part of the ink absorbing members 45a to 45d to the inside of the waste ink tank 27. Here, the inside of the used waste ink tank 27 cleaned. At this time, the outside of the waste ink tank may also be cleaned.

Then, a part of the film member remaining in the opening 48 is shaved and removed (S308)

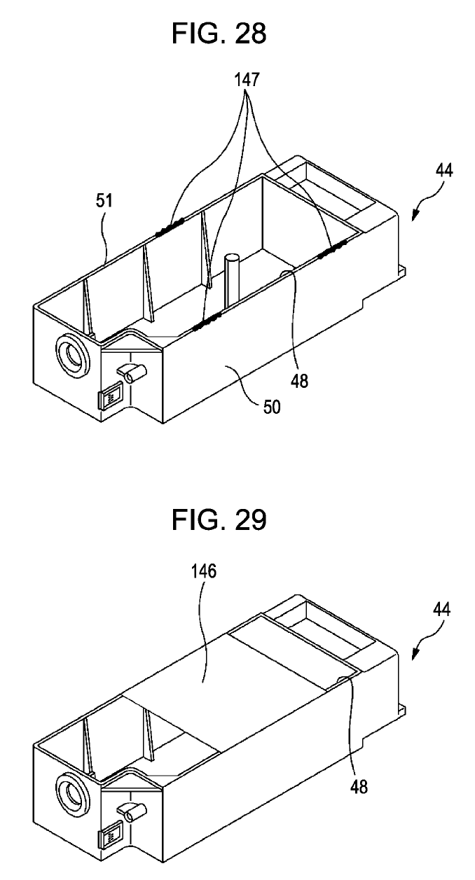

FIG. 28 is a diagram illustrating a state where a part 147 of the film member is attached to the periphery of the opening 48. When a part 147 of the film member remaining at the time of detaching the film member is attached to the periphery of the opening, a gap may be generated between the film member 46 and the container member 44 at the time of welding the film member 46 to the container member 44. Accordingly, it is preferable that the periphery of the opening 48 should be shaved to flatten the surface to which the film member 46 would be welded before sealing at least a part of the opening 48. Here, a part 147 of the film member remaining around the opening 48 is shaved. After the opening is flattened, the entire surface of the opening 48 can be sealed with a film member having the same outer shape as the film member 46 shown in FIG. 3.

Then, at least a part of the opening 48 is sealed with a new film member (S310). In this embodiment, at least a part of the opening 48 is sealed without receiving a new ink absorbing member in the waste ink tank. This is because the waste ink can be stored in the container member 44 without using the ink absorbing member. At the time of sealing the opening 48, the film member 27 can be welded to cover the entire surface of the opening 48 (similarly to the old waste ink tank 27). Only a part of the opening 48 may be stopped with the film member.

FIG. 29 is a diagram illustrating a state where the film member 146 is welded to a part of the opening 48. In the drawing, a recycled waste ink tank 127 to which the film member 146 is welded is shown. At the time of recycling the container member 44, as shown in the drawing, the film member 146 may be thermally welded and attached to only a part of the opening 48. In this case, it can be determined from the non-sealed portion whether the recycled waste ink tank 127 is a recycled product or a new product. By sealing only a part of the opening 48, it is not necessary to form the air hole 113 in the film member.

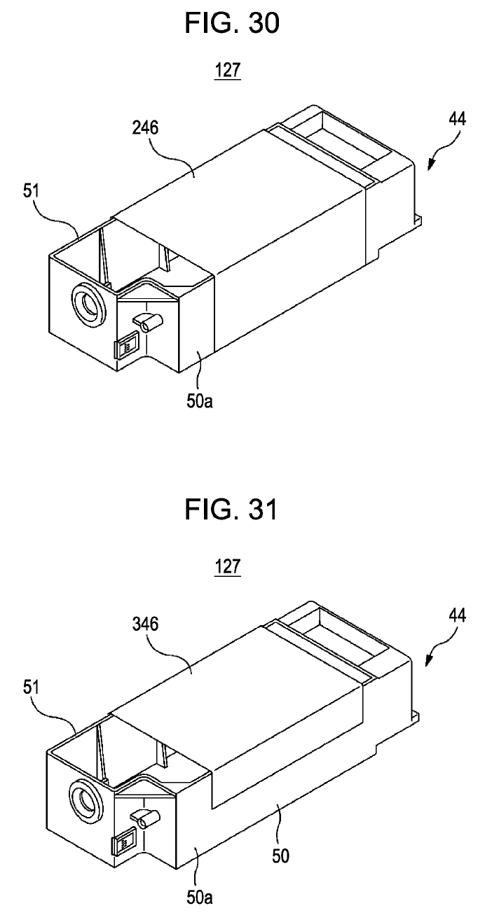

FIG. 30 is a diagram illustrating a state where the container member 44 is wound by the film member 246. In the drawing, a recycled waste ink tank 127 to which a film member 248 is attached is shown. At the time of sealing at least a part of the opening 48, as shown in the drawing, the film member 246 may be wound around the container member 44 so as to seal at least a part of the opening 48. The end of the film member 246 may be fixed with an adhesive. By attaching the film member 246 in this way, the film member 246 can be easily attached to the container member 44 even when a part of the old film member remains around the opening 48. It is possible to easily seal at least a part of the opening 48. A food wrapping film may be used as the film member 246 wound on the container member 44.

FIG. 31 is a diagram illustrating a state where a film member 346 is attached using a side wall of the container member 44. In the drawing, a recycled waste ink tank 127 to which the film member 346 is attached is shown. At the time of sealing at least a part of the opening 48, as shown in the drawing, end portions of the film member 346 may be bonded to the side walls 50 and 51 of the container member 44. By attaching the film member 346 in this way, the film member 346 can be easily attached to the container member 44 even when a part of the old film member remains around the opening 48.

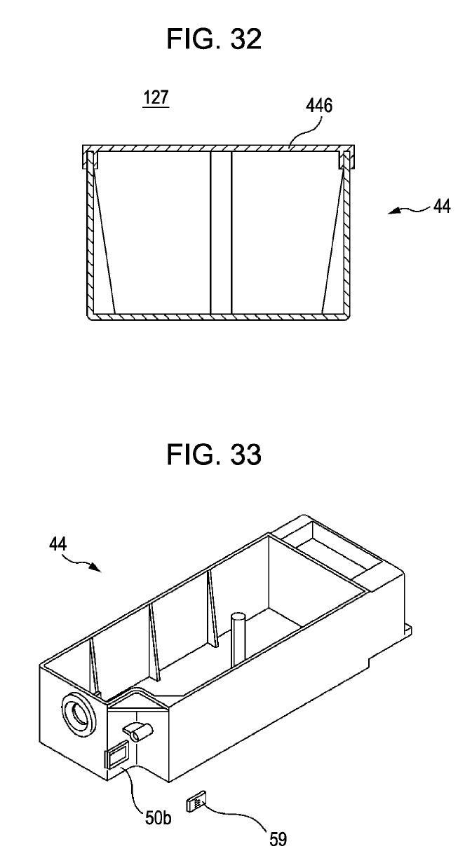

FIG. 32 is a sectional view illustrating a state where a lid member 446 is attached to at least a part of the opening 48 of the container member 44. In the drawing, a section of a recycled waste ink tank 127 to which the lid member 446 is attached is shown. As shown in the drawing, at the time of sealing at least a part of the opening 48, the lid member 446 fitted to the top portions of the side walls 50 and 51 of the container member 44 may be attached. By providing the lid member 446, it is possible to easily extract the ink absorbing members from the opening 48 at the time of recycling the container member 44.

The sealing of at least a part of the opening 48 includes the sealing of the entire opening 48 as shown in FIG. 3.

In this way, when the opening 48 of the container member 44 is sealed, information on the waste ink tank is then rewritten to the circuit board of the connection terminal 59 (S312).

The circuit board is formed in the connection terminal 59. The circuit board includes an EPROM (Erasable Programmable ROM) which information can be erased from and written to and stores a variety of information on the waste ink tank 127. For example, the number of reusable times of the container member 44, the amount of collectable ink of the waste ink tank, and the manufacturing date of the waste ink tank are stored in the circuit board.

The amount of collectable ink is predetermined for the waste ink tank 127. Accordingly, whenever the waste ink is discharged to the waste ink tank 127, the printer 11 counts the amount of discharged ink, subtracts the amount of discharge ink from the amount of collectable ink stored in the circuit board, and rewrites the result. Therefore, by allowing the circuit board to store the amount of collectable ink, the printer 11 can monitor the amount of collectable ink of the waste ink tank 127 so that the amount of discharged waste ink should not exceed the amount of collectable ink.

At the time of recycling the waste ink tank 127, the stored amount of collectable ink can be rewritten to the circuit board so as to be the amount of collectable ink of a non-used waste ink tank. For example, when the amount of collectable ink of the waste ink tank is reduced to 0 g by use, the amount of collectable ink is rewritten to the circuit board as 60 g which is the amount of collectable ink of a non-used waste ink tank, at the time of recycling the waste ink tank 27.

Since the recycled waste ink tank 127 is a recycled product, a smaller amount of collectable ink may be rewritten. For example, 60 g is written to the circuit board as the amount of collectable ink of a new waste ink tank 27, but 50 g may be rewritten as the amount of collectable ink to the circuit board of the recycled waste ink tank 127.

The number of reusable times of the container member 44 may be stored in the circuit board and the number of reusable times of the container member 44 may be reduced and stored in the circuit board when ever the waste ink tank 127 is recycled. Accordingly, it is possible to know the lifetime of the container member 44. For the following reason, it is necessary to know the lifetime of the container member 44.

As described above, at the time of recycling the container member 44, the welding surface of the film member may be shaved. Then, the shaved portion increases with the increase of the number of reused times and thus the height of the container member 44 may be reduced. In this case, there is a problem in that the ink absorbing member having an expected size may not be received or only an amount of waste ink smaller than an expected amount of collectable ink can be collected. Accordingly, the number of reused times of the container member 44 is stored in the circuit board to know the lifetime of the container member 44.

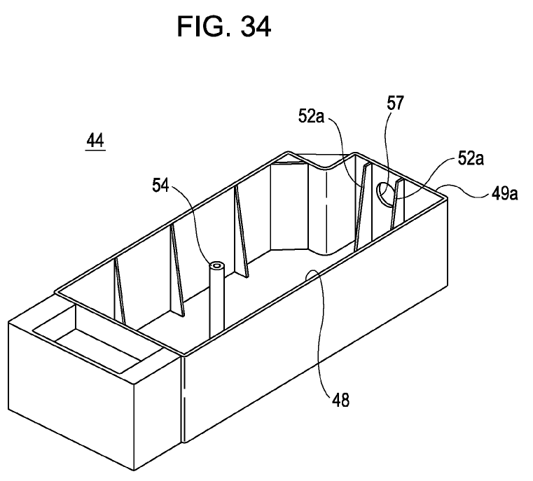

FIG. 33 is a diagram illustrating a state where the connection terminal 59 is demounted from the container member 44. In this way, at the time of updating the details stored in the circuit board 59a, the connection terminal 59 may be demounted from the container member 44. The connection terminal 59 may be demounted from the container member 44 and then a new connection terminal may be mounted thereon.

As described above, when the waste ink tank 127 is recycled reusing the container member 44, the recycled waste ink tank 127 is attached to the printer 11 (S314). Since the recycled waste ink tank 127 is manufactured using the container member 44, the outer shape thereof is almost the same as the old waste ink tank 27. Accordingly, the recycled waste ink tank can be attached to the printer 11, similarly to the old waste ink tank 27.

The processes of steps S304 to S312 may be performed by a person other than the user.

FIG. 34 is a diagram illustrating the ribs 52a in the vicinity the connection port 57 in the container member 44. The ribs 52a extend from the inner bottom surface of the container member 44 and are connected to both lateral sides of the connection port 57.

The cut-in groove 62 guiding the front tubular portion 76 and the non-tubular portion 77 to the center of the container member 44 is disposed in the ink absorbing member 45c of the old waste ink tank 27. However, in the recycled waste ink tank 127 according to this embodiment, the ink absorbing members 45a to 45d are not received in the container member 44 and the cut-in groove 62 guiding the front tubular portion 76 to the center of the container member 44 does not exist.

In this case, since the ribs 52a are disposed in the container member 44, the ribs 52a can guide the front tubular portion 76 and the non-tubular portion 77 to the center of the container member 44 after the front end of the front tubular portion 76 is inserted into the connection port 57. Accordingly, even when the ink absorbing members 45a to 45d guiding the front tubular portion 76 do not exist, the front tubular portion 76 is effectively guided to the center of the container member 44.

The ribs 52a contribute to an increase in strength of the container member 44, which is the inherent purpose of the ribs. Particularly, since the waste ink tank 27 is disposed in the printer 11, the insertion of the front tubular portion 76 into the connection port 57 is hardly visible to a user replacing the waste ink tank 27. Therefore, at the time of attaching the recycled waste ink tank 127 into the printer 11, the front tubular portion 76 may frequently collide with the periphery of the connection port 57. In this case, since the ribs 52a reinforce the periphery of the connection port 57, the container member 44 is not easily damaged and can be recycled.

In this way, the ribs 52a facilitate the installation of the waste ink tank 27 which is installed at a position not visible to a user and facilitates the recycling of the container member.

Other modifications of the third embodiment of the invention will be described now.

Although an ink jet printer is embodied as a fluid ejecting apparatus having the recycled waste liquid collector (waste ink tank) reusing the container member in the above-mentioned embodiment, the invention may be applied to a fluid ejecting apparatus spraying or ejecting a liquid (including a liquid-like material in which particles of a functional material are dispersed and a colloidal material such as gel, in addition to the liquid) other than the ink or a fluid (such as solid that can be made to flow and ejected as a fluid) other than the liquid. For example, the fluid ejecting apparatus may be a liquid-like material ejecting apparatus ejecting a liquid-like material in which materials such as an electrode material or a coloring material used for manufacturing a liquid crystal display, an electroluminescence (EL) display, and a surface-emission display are dispersed or melted, a liquid ejecting apparatus ejecting bio organics used for manufacturing a bio chip, or a liquid ejecting apparatus used as a precise pipette to eject a liquid as a sample. In addition, the fluid ejecting apparatus may be a liquid ejecting apparatus ejecting lubricant to a precise machine such as a clock or a camera by the use of a pin point, a liquid ejecting apparatus ejecting a transparent resin liquid such as a UV-curable resin onto a substrate to form a micro semi-circular lens (optical lens) used in an optical communication device, a liquid ejecting apparatus ejecting etchant such as acid or alkali to etch a substrate and the like, a colloidal material ejecting apparatus ejecting such as gel, or a powder-ejecting recording apparatus ejecting a solid such as toner powder. The invention can be applied to one of the above-mentioned ejecting apparatuses.

In this embodiment, the ink includes aqueous ink and oily ink.

The above-mentioned embodiment is intended for easy understanding of the invention, but not for definitely analyzing the invention. The invention can be modified and improved without departing from the gist thereof and equivalents thereof can be included in the invention. The embodiments are also included in the invention.

What is claimed is:

1. A method of recycling a container member containing a waste liquid absorbing member, the method comprising:
removing at least a part of waste liquid from the waste liquid absorbing member having absorbed the waste liquid; and
disposing the waste absorbing member, which at least a part of the waste liquid is removed from, in the container member.

2. The method according to claim 1, wherein the removing of at least a part of the waste liquid from the waste liquid absorbing member includes at least one of cleaning the waste liquid absorbing member, squeezing the waste liquid absorbing member, wiping the waste liquid absorbing member, and cleaning the container member as a whole with the waste liquid absorbing member contained therein.

3. The method according to claim 1, wherein the waste liquid absorbing member includes a plurality of waste liquid absorbing members, and
wherein the waste liquid absorbing member from which the waste liquid is more removed is disposed in a lower part in the container member in the disposing of the waste liquid absorbing member, which at least a part of the waste liquid is removed from, in the container member.

4. The method according to claim 1, wherein the waste liquid absorbing member from which a part of the waste liquid is removed and a non-used waste liquid absorbing member are disposed in container member in the disposing of the waste liquid absorbing member, which at least a part of the waste liquid is removed from, in the container member.

5. The method according to claim 4, wherein an outer shape of the non-used waste liquid absorbing member is different from the outer shape of the waste liquid absorbing member from which a part of the waste liquid is removed.

6. The method according to claim 1, further comprising sealing at least a part of an opening of the container member.

7. The method according to claim 6, wherein the sealing of at least a part of the opening of the container member includes at least one of shaving at least a part of a top portion of a side wall constituting the opening and attaching a sealing member to the top portion of the side wall, winding the sealing member around the container member, attaching the sealing member to a side wall surface of the container member, and providing a lid member inserted into at least a part of the top portion of the side wall of the container member.

8. The method according to claim 1, wherein the container member includes a memory device storing information on an amount of the collected waste liquid, and
wherein the method further comprises at least one of rewriting the information on the amount of collected waste liquid to the memory device and replacing the memory device with a new memory device.

9. A method of recycling a container member containing a waste liquid absorbing member, comprising:
removing the waste liquid absorbing member absorbing a waste liquid from the container member; and
disposing a different waste liquid absorbing member in the container member instead of the removed waste liquid absorbing member.

10. The method according to claim 9, wherein the different waste liquid absorbing member disposed instead of the removed waste liquid absorbing member has the same shape as the outer shape of the removed waste liquid absorbing member, or has a shape different from the outer shape of the removed waste liquid absorbing member, or is disposed in a part of the container member.

11. The method according to claim 10, wherein the different waste liquid absorbing member disposed instead of the removed waste liquid absorbing member is divided into a plurality of waste liquid absorbing members and is disposed in the container member.

12. The method according to claim 11, wherein a connection port which a liquid passage can be inserted into and detached from is formed in the container member, and
wherein the different waste liquid absorbing member disposed instead of the removed waste liquid absorbing member is disposed close to the connection port in the container member.

13. The method according to claim 9, further comprising sealing at least a part of an opening of the container member.

14. The method according to claim 13, wherein the sealing of at least a part of the opening of the container member includes at least one of shaving at least a part of a top portion of a side wall constituting the opening and attaching a sealing member to the top portion of the side wall, winding the sealing member around the container member, attaching the sealing member to a side wall surface of the container member, and providing a lid member inserted into at least a part of the top portion of the side wall of the container member.

15. The method according to claim 9, wherein the container member includes a memory device storing information on an amount of the collected waste liquid, and
wherein the method further comprises at least one of rewriting the information on the amount of collected waste liquid to the memory device and replacing the memory device with a new memory device.

16. A method of recycling a container member containing a waste liquid absorbing member, comprising:
removing the waste liquid absorbing member having absorbed a waste liquid from an opening of the container member;
sealing at least a part of the opening of the container member from which the waste liquid absorbing member is removed; and
cleaning the inside of the container member after removing the waste liquid absorbing member.

17. The method according to claim 16, wherein the sealing of at least a part of the opening of the container member includes at least one of shaving at least a part of a top portion of a side wall constituting the opening and attaching a sealing member to the top portion of the side wall, winding the sealing member around the container member, attaching the sealing member to a side wall surface of the container member, and providing a lid member inserted into at least a part of the top portion of the side wall of the container member.

18. The method according to claim 17, wherein the container member includes a connection port which a liquid passage can be inserted into and detached from and a rib extending from the bottom of the container member to the vicinity of the connection port, and
wherein the rib guide the liquid passage in a predetermined direction in the container member at the time of inserting the liquid passage.

19. The method according to claim 16, wherein the container member includes a memory device storing information on an amount of the collected waste liquid, and
wherein the method further comprises at least one of rewriting the information on the amount of collected waste liquid to the memory device and replacing the memory device with a new memory device.
